(19) United States
(12) Patent Application Publication
(10) Pub. No.: US 2024/0426730 A1
(43) Pub. Date: Dec. 26, 2024

(54) System and Method for Clustering and Deconvolution of Particle Phenotype

(71) Applicant: TDK U.S.A. Corporation, Uniondale, NY (US)

(72) Inventor: Rakesh Sethi, San Jose, CA (US)

(73) Assignee: TDK U.S.A. Corporation, Uniondale, NY (US)

(21) Appl. No.: 18/746,011

(22) Filed: Jun. 17, 2024

Related U.S. Application Data
(60) Provisional application No. 63/522,399, filed on Jun. 21, 2023.

(51) Int. Cl. G01N 15/02; G01N 15/10; G01N 15/12

(52) U.S. Cl. CPC G01N 15/0266; G01N 15/1023; G01N 15/12

(57) ABSTRACT

A system for classifying individual particles includes a microfluidic device and an electronic device. The microfluidic device includes a microfluidic channel arranged on a first substrate, an optical or magnetic sensing zone arranged along a first portion of the microfluidic channel, and an electrical sensing zone arranged along a second portion of the microfluidic channel. The system obtains a plurality of impedance values corresponding to a plurality of sample particles of a target sample, and inputs the plurality of impedance values into a first target particle classification model. The system applies, locally in the electronic device, the first target particle classification model to the plurality of impedance values to determine a respective particle type classification for each particle of the plurality of sample particles.

### RELATED APPLICATIONS

This application claims the benefit of U.S. Provisional Patent Application No. 63/522,399, filed Jun. 21, 2023, which is incorporated by reference herein in its entirety.

This application is related to the following patent applications, each of which is incorporated by reference herein in its entirety:
U.S. patent application Ser. No. 17/970,569, filed Oct. 21, 2022, which is a continuation-in-part of U.S. patent application Ser. No. 17/589,591, filed Jan. 31, 2022;
U.S. patent application Ser. No. 17/589,593, filed Jan. 31, 2022;
U.S. patent application Ser. No. 18/655,717, filed May 6, 2024, which claims priority to U.S. Provisional Patent Application No. 63/467,903, filed May 19, 2023;
U.S. patent application Ser. No. 18/529,856, filed Dec. 5, 2023, which claims priority to U.S. Provisional Patent Application No. 63/432,777, filed Dec. 15, 2022; and
U.S. patent application Ser. No. 18/466,737, filed Sep. 13, 2023, which claims priority to U.S. Provisional Patent Application No. 63/406,851, filed Sep. 15, 2022.

### TECHNICAL FIELD

This application relates generally to microfluidic analysis, and more particularly to systems, devices, methods, and non-transitory computer-readable storage medium for classifying cells or particles of a tissue sample using a microfluidic device.

### BACKGROUND

Cell plasticity refers to an ability of cells to change their phenotypes in response to changes in their environment without causing genetic mutation. In some cases, cell plasticity of diseased cells (e.g., cancer cells) in tumors can push the tumors to evolve and resist drugs.

### SUMMARY

In accordance with at least some embodiments disclosed herein is the realization that it is challenging to quantify plasticity of single cells extracted from various tissues of diseased cells at a single cell level. Diseased cells exhibit phenotypic changes that are not observed in normal cells. Sub-populations of diseased cells can also demonstrate heterogeneity or variability that leads to fine morphological changes. These phenotypic or morphological changes are detected when characteristics of phenotypical surface and sub-surface texture of the diseased cells are measured during an extended duration of time. Further, in accordance with at least some embodiments disclosed herein is the realization that detection efficiency and effectiveness of certain cell sorting methods (e.g., fluorescence activated cell sorting (FACS), dye labeling, optical detection, magnetic label detection) are not consistent and are highly dependent on enrichment of a corresponding sample preparation process. In some situations, tools and techniques do not have a sufficiently high sensitivity to detect fine phenotypic changes in some cells.

Accordingly, there is a need for improved systems, methods, and devices that enable phenotype analysis of cells at a single cell level.

Some embodiments of the present disclosure are directed to classifying unlabeled cells using a microfluidic device that measures signals (e.g., impedance or current signals) from unlabeled cells at a single cell level.

Some embodiments disclosed herein are directed to a system for classifying individual particles (e.g., cells). In some embodiments, the disclosed system includes a microfluidic device and an electronic device. The microfluidic device includes a microfluidic chip and one or more impedance sensors. Particles, such as cells, can be processed through the microfluidic chip and probed via impedance probing using the impedance sensors using suitable software-selectable parameters that allow the system controller and circuit of the microfluidic device to measure differences in current or impedance signals, to identify the specific phenotype fingerprint of the particle. In some embodiments, the particles comprise a tissue sample of cells that is partitioned into blocks (e.g., solid blocks) of cells, without the need to label the cells, as described in U.S. patent application Ser. No. 18/529,856, filed Dec. 5, 2023, titled “Method and Classification System for Single Cell Analysis,” the contents of which are incorporated by reference herein in its entirety.

As disclosed herein, in some embodiments, the system includes a microcontroller unit (MCU) that is configured to facilitate measurement and live streaming of impedance metrics of the particles (e.g., time series impedance data) as each individual particle passes under the electrodes on the chip. In some embodiments, the time series impedance data are processed through an entropy engine software that further provides spatial transcriptomic classification and visualization of the particles.

As disclosed herein, in some embodiments, the system also provides a ground truth of concurrent optical or magnetic signatures gathered by a plurality of optical and magnetic sensors that are either part of the system or are communicatively coupled to the system. Such orthogonal database (e.g., database of optical data and magnetic data) is then correlated to the impedance data of the particles. For example, the transcript libraries can be correlated to a Genomics database. In some embodiments, data provided by optical magnetic measurements are used for coarse classification, and the impedance data are used for fine classification.

As disclosed herein, the disclosed systems and methods provide faster and more accurate classification compared to existing cell classification approaches. For example, current cell classification methods, such as optical-based methods, involve collecting large datasets that include optical images of cells and are performed on fragmented platforms that are disjointed. Processing the optical images requires a large amount of compute power and also has large latency and error rates. The phenotype data of the cells can only be obtained after the post-processing step. Optical-based classification methods also tend to miss out on certain diseased cells, which exhibit weak optical signatures and appear as noise in the system, thus leading to poor promiscuity differentiation. The optical signal is also a weak measure of signaling entropy because of its inability to separate the cellular subtypes. By contrast, impedance probing allows for label free examination and classification such that the diseased cells exhibit differing impedance fingerprints. Such phenotypical impedance signals are highly correlated to the signaling entropy and can be used to classify the heterogeneous mixture and identify, and distinguish between, normal and diseased cells.

In some embodiments, the size of the blocks can be tailored (e.g., selected or modified) according to achieve a desired signal-to-noise ratio. The disclosed systems and methods are superior to existing optical-based classification approaches because the signaling entropy is directly measured from the measured impedance of the single cell passing through the impedance sensor on the microfluidic chip.

In some embodiments, the advantages of the disclosed systems and methods include, and are not limited to: (1) providing a low latency and high accuracy method of measuring the entropy of individual particles or single biological cells, where in some embodiments, a cell classification can be obtained within 2 milliseconds; (2) providing a faster method of refining weights of machine learning data of the same particles or cells from prior acquired optical data; (3) providing a less memory intensive method of applying the refined electrical model to detect an anomaly in individual particles or single biological cells substantially in real time, (4) providing a low-power edge compute-heavy method of applying the integer-only compute using MCU to achieve the same level of accuracy as optical methods; (5) building an inference model for single cell or particle morphology detection substantially in real time; and (6) providing a smart microfluidic structure with edge compute using MCU and a low memory capacity.

In accordance with some embodiments, a system for classifying individual particles comprises a microfluidic device. The microfluidic device includes a microfluidic channel arranged on a substrate, an optical or magnetic sensing zone arranged along a first portion of the microfluidic channel, and an electrical sensing zone arranged along a second portion of the microfluidic channel. The system comprises an electronic device having one or more processors and memory. The memory stores one or more programs configured for execution by the one or more processors. The one or more programs include instructions for: obtaining a plurality of impedance values corresponding to a plurality of sample particles of a target sample, wherein a respective particle of the sample particles corresponds to a respective impedance value of the plurality of impedance values; inputting the plurality of impedance values into a first target particle classification model; and applying, locally in the electronic device, the first target particle classification model to the plurality of impedance values to determine a respective particle type classification for each particle of the plurality of sample particles.

In accordance with some embodiments, a microfluidic device comprises a microfluidic channel arranged on a first substrate, an optical sensing zone arranged along a first portion of the microfluidic channel, and an electrical sensing zone arranged along a second portion of the microfluidic channel. The electrical sensing zone includes a set of (e.g., one or more) electrodes and a set of (e.g., one or more) piezoelectric actuators.

In accordance with some embodiments, a system includes memory and one or more processors. The memory stores a plurality of instructions and data configured for execution by the one or more processors. The plurality of instructions includes instructions for performing any of the methods disclosed herein.

In accordance with some embodiments, a non-transitory computer-readable storage medium stores one or more programs configured for execution by a computing device having one or more processors and memory. The one or more programs include instructions for performing any of the methods described herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A shows a microfluidic device for flow control of cells or particles in a microfluidic channel in accordance with some embodiments.

FIG. 1B shows a microfluidic device for flow control of cells or particles in a microfluidic channel in accordance with some embodiments.

FIG. 1C shows a microfluidic device for flow control of cells or particles in a microfluidic channel in accordance with some embodiments.

FIG. 2 is a block diagram illustrating electrical components for flow control of cells or particles in a microfluidic channel in accordance with some embodiments.

FIG. 3 illustrates a workflow for classifying single cells, in accordance with some embodiments.

FIG. 4 is an exemplary block diagram of a system for classifying individual particles, in accordance with some embodiments.

FIG. 5 is another exemplary block diagram of a system for classifying individual particles, in accordance with some embodiments.

FIGS. 6A to 6E are various views of a holder device, in accordance with some embodiments.

FIG. 7 illustrates a process for classifying particles, in accordance with some embodiments.

FIG. 8 illustrates a user interface of an entropy engine application that is displayed on a display device, in accordance with some embodiments.

FIGS. 9A to 9C provide a flowchart of an example process for classifying individual particles, in accordance with some embodiments.

### DESCRIPTION OF EMBODIMENTS

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

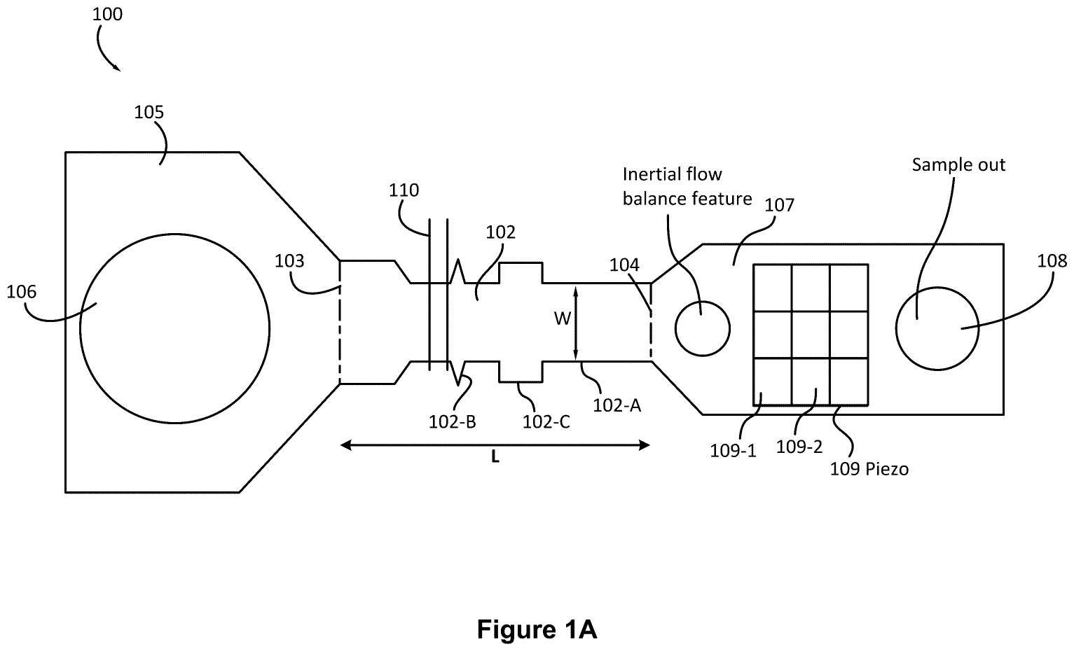

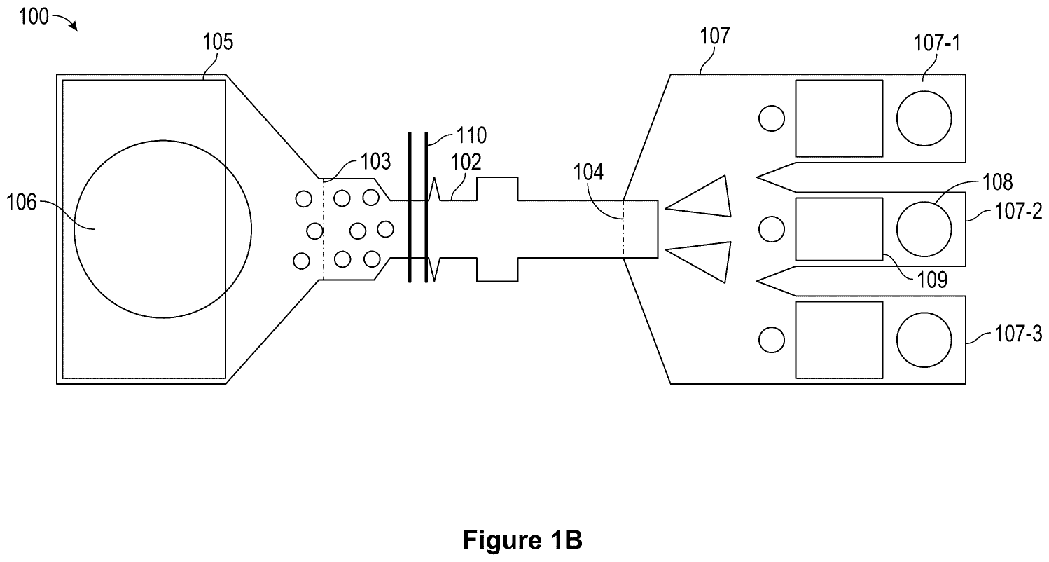

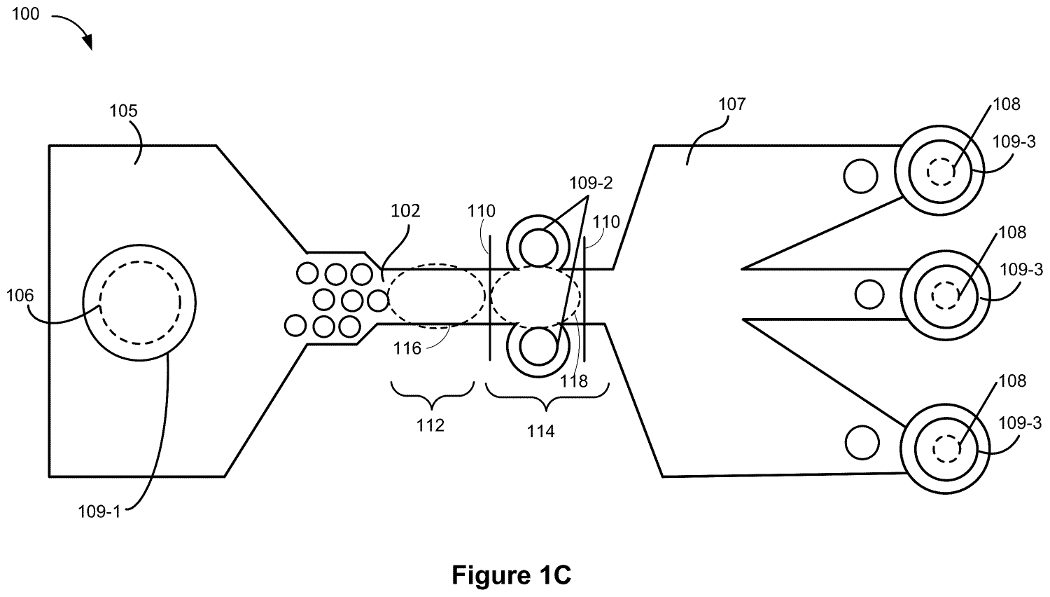

FIG. 1A shows a microfluidic device 100 in accordance with some embodiments. The device 100 includes a fluid channel 102 (e.g., a microfluidic channel) formed on a first substrate. In some embodiments, the fluid channel 102 may be formed by coupling a first substrate with an indentation, recess, or notch with a second substrate so that the fluid channel 102 is defined between the first substrate and the second substrate.

The fluid channel 102 has an inlet 103 and an outlet 104, both of which are illustrated by dashed lines in FIG. 1A. The locations of the inlet 103 and the outlet 104 shown with respect to the fluid channel 102 in FIG. 1A, are mere examples. The inlet 103 and the outlet 104 may be defined at any other location along the length dimension of the fluid channel 102 or the device 100. In some embodiments, the length of the fluid channel 102, L (e.g., measured from the inlet 103 to the outlet 104), is in the range of 1 mm to 50 mm. In some embodiments, a width W (e.g., a representative portion, such as 102-A, which may be the narrowest portion) of the fluid channel 102 may be configured based on the size of the particle to be analyzed. For example, for cellular measurements, the width W of the fluid channel 102 is configured in accordance with the size of the cell such that only a single cell is detected at a time. In some embodiments, the width W of the fluid channel 102 is in the range of 10 μm to 200 μm (e.g., 50 μm). In some embodiments, the fluid channel 102 includes one or more portions that have a width different from the width W. For example, as shown in FIG. 1A, the fluid channel 102 may include portions 102-B and 102-C having (protruding) shapes such that widths of the portions 102-B and 102-C are greater than the width W. Similarly, the fluid channel 102 may include one or more portions with widths narrower than the width W. In some embodiments, the wider the fluid channel 102 is, the slower is the velocity of the particles flowing in the corresponding portion of the fluid channel 102 (e.g., when the fluid channel 102 has a uniform height). As such, for example, the wider portion 102-C is used to reduce the velocity of the particles (e.g., immobilize the particles), which allows for more time for analyzing the particles.

The device 100 includes an input region 105 for receiving at an inlet port 106 a sample fluid with particles (e.g., cells) as an input to the device 100 and providing the sample fluid from the inlet port 106 to the fluid channel 102 via the inlet 103. The device 100 further includes an output region 107 for collecting at least a portion of the sample fluid from the fluid channel 102 via the outlet 104 and ejecting or delivering the sample fluid portion via an outlet port 108 (e.g., a nozzle) for further processing or analysis. In some embodiments, the diameter of the outlet port 108 is in the range of 60 microns to 120 microns. In some embodiments, the fluid channel 102 is configured such that the inlet port 106 is the inlet 103 and the outlet port 108 is the outlet 104 of the fluid channel 102.

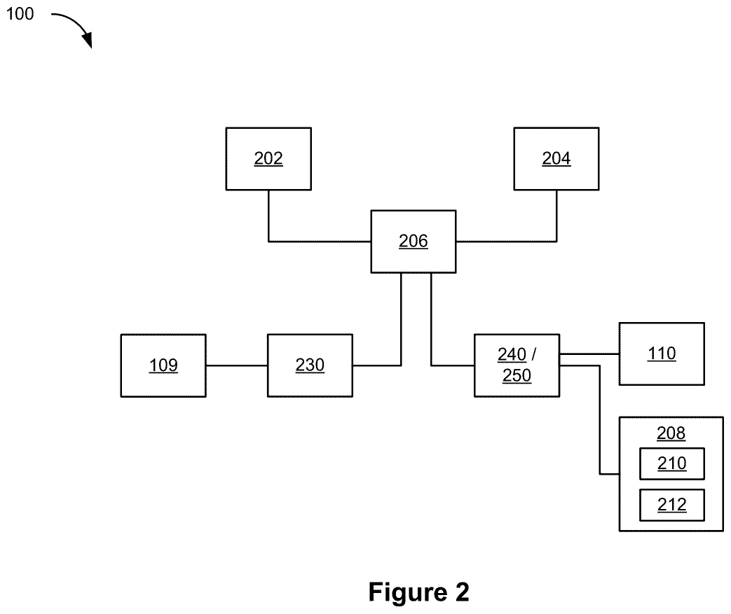

In some embodiments, the output region 107 includes a first array of piezoelectric actuators 109 located adjacent to the outlet 104 for ejecting a portion of the fluid in the fluid channel 102. In some embodiments, the first array of piezoelectric actuators 109 includes one or more piezoelectric actuators (e.g., a piezo micro-electro-mechanical system (MEMS) actuator). In some embodiments, the first array of piezoelectric actuators 109 includes two or more piezoelectric actuators (e.g., piezo actuators 109-1 and 109-2). In some embodiments, each of the first array of piezoelectric actuators 109 is a piezoelectric element. The piezoelectric element may have a length equal to 1 mm and a width equal to 0.5 mm. In some embodiments, the device 100 includes actuation circuitry (e.g., actuation circuitry 230 described with respect to FIG. 2) electrically coupled to the first array of piezoelectric actuators 109. In some embodiments, upon application of an electrical signal from the actuation circuitry, the first array of piezoelectric actuators 109 generates oscillations that create displacement as well as acoustic waves, which controls localized inertial movement of the particles in the fluid channel 102 in the three-dimensional x, y and z planes with sub-micron level control. In some embodiments, the first array of piezoelectric actuators 109 induces a laminar flow from the inlet 103 toward the outlet 104.

In some embodiments, the device 100 includes one or more pairs of electrodes 110 (e.g., a pair of electrodes). The one or more pairs of electrodes 110 may be used for charging particles flowing through the fluid channel 102 so that the particles can be manipulated with an electrical field. In some embodiments, the distance between a pair of the electrodes 110 is configured such that only a single cell is manipulated with an electrical field at a time.

In some embodiments, one or more pairs of electrodes 110 are also referred to as electromagnetic field generators. For example, in some embodiments, the one or more pairs of electrodes 110 may be configured to apply a preset frequency to the input cells. In some embodiments, the preset frequency corresponds to a particular type of cell abnormality. In some embodiments, the preset frequency is in the range of 1 kHz to 10 GHZ.

In some embodiments, the device 100 includes a microfluidics sensor chip 208. In some embodiments, the device includes one or sensors 210 (e.g., that is coupled on sensor chip 208 described with respect to FIG. 2). The one or more sensors 210 are configured to detect signal changes, such as impedance or current changes (e.g., single ended or double ended differential) as a single cell passes through the fluid channel 102 (e.g., through or under the one or more pairs of electrodes 110).

In some embodiments, the device 100 is capable of measuring signal profiles (e.g., impedance profiles or current profiles) of cells with single cell sensitivity. For example, in some embodiments, the device 100 includes a transimpedance amplifier 212 (e.g., coupled to the sensor chip 208) that is capable of generating signal profiles of cells as a single cell passes through the fluid channel 102 (e.g., through or under the one or more pairs of electrodes 110). In some embodiments, generating the signal profile includes measuring one or more capacitance values for a cell (e.g., due to diseased cells having higher capacitance values than normal (non-diseased) cells, and consequently diseased cells have higher impedance values than normal cells).

In some embodiments, the device 100 is configured to measure an impedance of the input cells. In some embodiments, the device 100 is configured to measure an impedance of the input cells in response to a preset frequency (e.g., applied by the one or more pairs of electrodes 110). In some embodiments, each measurement of impedance of the input cells is performed with a different set of parameters. For example, in some embodiments, the set of parameters include an applied frequency (or a lock-in frequency), a flow rate, and a sample fluid mixture. In some embodiments, the processing time for each cell sample is in a time range of 0.5 seconds to 300 seconds.

In some embodiments, the device 100 includes driver circuitry (e.g., driver circuitry 240 described with respect to FIG. 2) electrically coupled to the one or more pairs of electrodes 110. In some embodiments, the driver circuitry is configured to produce electrical signals in the MHz and GHz frequency domains. In some embodiments, the frequency of the electrical signals provided to the one or more pairs of electrodes 110 depends on a type or types of the particles to be analyzed using the device 100.

In some embodiments, the output region 107 is divided into a plurality of output sub-regions (e.g., sub-regions 107-1 through 107-3) as shown in FIG. 1B. In some embodiments, each output sub-region having an outlet port and at least one of the first array of piezoelectric actuators 109. In this embodiment, each of different portions (e.g., each portion corresponding to a particular cell or a type of cell) of the sample fluid from the outlet 104 is deflected toward a corresponding output sub-region of the output region 107. As such, each of the different portions of the sample fluid is collected at and ejected from the corresponding output sub-region. The deflection of the different portions of the sample fluid may be achieved, for example, by the oscillations and displacement caused by the activation of the first array of piezoelectric actuators 109 (and/or other piezoelectric actuators implemented in or operationally associated with the device 100).

FIG. 1C illustrates a microfluidic device 100 for flow control of cells or particles in a microfluidic channel in accordance with some embodiments. The device 100 includes a fluid channel 102 (e.g., a microfluidic channel) formed on a substrate. In some embodiments, the substrate is composed of silicon (e.g., is a silicon or silicon-on-insulator substrate).

The device 100 includes an input region 105 for receiving at an inlet port 106 (e.g., sample inlet) a sample fluid with particles (e.g., cells) as an input to the device 100 and providing the sample fluid from the inlet port 106 to the fluid channel 102. In some embodiments, the input region 105 includes a set of (e.g., one or more) piezoelectric actuators 109-1 located adjacent to the inlet port 106 for facilitating flow of the sample fluid from the inlet port 106 to the fluid channel 102.

The device 100 includes an output region 107 for collecting at least a portion of the sample fluid from the fluid channel 102, and ejecting or delivering the sample fluid portion via outlet ports 108 (e.g., a nozzle) for further processing or analysis. In some embodiments, the output region 107 includes a set of e.g., one or more) piezoelectric actuators 109-3 located adjacent to the outlet ports for facilitating ejection or delivery of the sample fluid portion via outlet ports 108.

In some embodiments, the fluid channel 102 includes an optical or magnetic sensing zone 116 arranged along a first portion 112 of the fluid channel 102 (e.g., the portion that is closer to the input region 105). In some embodiments, the fluid channel 102 is formed by coupling the first substrate with a second substrate via a bonding layer. In some embodiments, the second substrate is composed of glass or plastic material. In some embodiments, a portion of the second substrate is at least partially transparent such that optical sensing in the optical or magnetic sensing zone 116 is performed through the second substrate. In some embodiments, the bonding layer comprises a polymer layer.

In some embodiments, the fluid channel 102 includes an electrical sensing zone 118 arranged along a second portion 114 of the fluid channel 102 (e.g., the portion that is closer to the output region 107). The electrical sensing zone 118 includes a set of (e.g., one or more) electrodes 110 that are configured to apply an electric field to a particle in the electrical sensing zone. The electrical sensing zone 118 includes a set of (e.g., one or more) piezoelectric actuators 109-2 that are configured to cause manipulation of a particle while the particle is in the electrical sensing zone.

FIG. 2 is a block diagram illustrating electrical components for flow control of particles in a fluid channel in accordance with some embodiments. In some embodiments, the device 100 includes one or more processors 202 and memory 204. In some embodiments, the device 100 includes a microfluidics sensors chip 208. The device includes one or more sensors 210 (e.g., coupled to the sensor chip 208). In some embodiments, the one or more sensors 210 include an impedance sensor configured to detect impedance or current changes as a single cell passes through a fluid channel 102. In some embodiments, the one or more sensors 210 include an optical sensor configured to sense particles of a fluidic sample.

In some embodiments, the device 100 includes a transimpedance amplifier 212 configured to generate a signal profile for cells. In some embodiments, the memory 204 includes instructions for execution by the one or more processors 202. In some embodiments, the stored instructions include instructions for providing actuation signals to the first array of piezoelectric actuators 109 (and/or other arrays of actuators). In some embodiments, the actuation signals for the arrays of piezoelectric actuators may be configured such that each array of piezoelectric actuators create oscillations at a different frequency from a frequency of oscillations of another array of piezoelectric actuators. For example, in some embodiments, the first array of piezoelectric actuators 109 may operate at a frequency in the range between 0.5 kHz and 100 kHz based on desired flow rates. In some embodiments, the stored instructions include instructions for providing actuation signals to the electrodes 110 for charging particles flowing through the fluid channel 102 so that the particles can be manipulated with an electrical field.

In some embodiments, the device also includes an electrical interface 206 coupled with the one or more processors 202 and the memory 204.

In some embodiments, the device further includes actuation circuitry 230, which is coupled to one or more piezoelectric actuators, such as the first array of piezoelectric actuators 109, The actuation circuitry 230 sends electrical signals to the one or more arrays of piezoelectric actuators 109 to initiate actuation of the one or more arrays of piezoelectric actuators.

In some embodiments, the device further includes driver circuitry 240, which is coupled to one or more electrodes, such as the electrodes 110. The driver circuitry 240 sends electrical signals to the one or more electrodes 110 to generate an electrical field using the one or more electrodes for charging particles flowing through the fluid channel 102.

In some embodiments, the device further includes readout circuitry 250, which is coupled to one or more electrodes, such as the electrodes 110. The readout circuitry 250 receives electrical signals from the one or more electrodes 110 and provides the electrical signals (with or without processing) to the one or more processors 202 via the electrical interface 206. In some embodiments, the readout circuitry 250 is coupled to one or more sensors, such as the sensors 210. The readout circuitry 250 receives signals (e.g., impedance signals or current signals) from the one or more sensors 210 and provides the signals (with or without processing) to the one or more processors 202 via the electrical interface 206.

### Methods and Systems for Clustering and Deconvolution of Particle Phenotype

Some embodiments of the present disclosure are directed to methods, devices, and systems for single cell phenotype analysis.

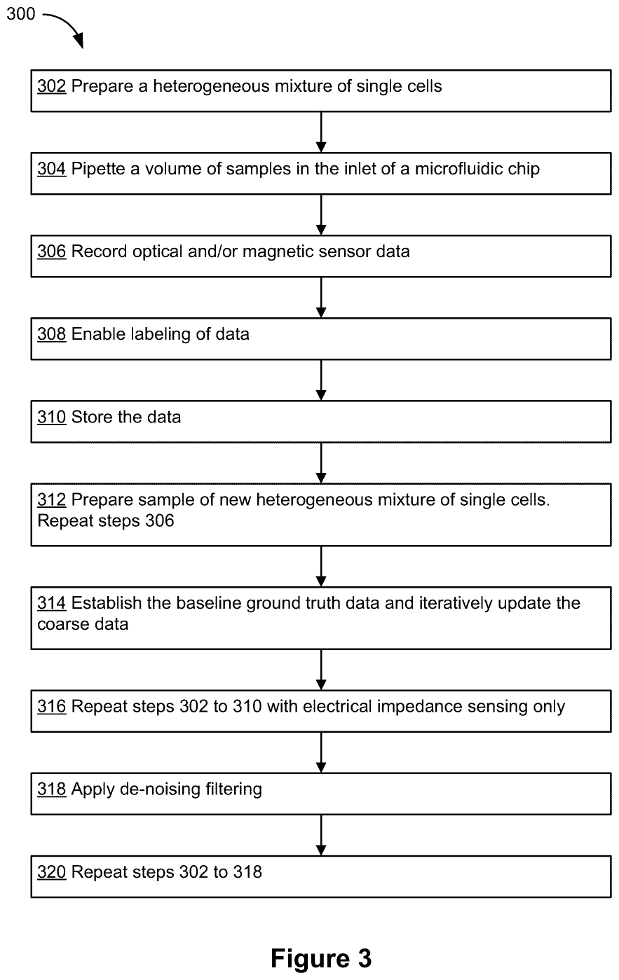

FIG. 3 illustrates a workflow process 300 for classifying single cells, in accordance with some embodiments.

In some embodiments, the workflow 300 includes, in step 302, preparing a heterogeneous mixture of single cells. In some embodiments, the heterogeneous mixture of single cells comprises cells that are tagged with optically detectable labels. In some embodiments, the heterogeneous mixture of single cells comprises cells that are tagged with magnetically detectable labels. In some embodiments, the heterogeneous mixture of single cells comprises cells that are not tagged with any label.

In some embodiments, the workflow 300 includes, in step 304, pipetting a volume (e.g., a fixed or predetermined volume, such as 10 microliters to 100 microliters) of samples in the inlet 106 of a microfluidic chip (e.g., microfluidic device 100).

In some embodiments, the workflow 300 includes, in step 306, setting up the flow in the chip channel such that single cell particles flow and record optical and/or magnetic sensor data detected by optical and/or magnetic sensors (e.g., sensors 210). In some embodiments, the microfluidic device includes (e.g., is coupled to) an optical sensor that is configured to collect optical signals (e.g., spectra and/or images) of the particles as a respective individual particle passes through the fluid channel 102. In some embodiments, the microfluidic device includes (e.g., is coupled to) a magnetic sensor that is configured to collect magnetic signals of the particles as a respective individual particle passes through the fluid channel 102. In some embodiments, the microfluidic device includes (e.g., is coupled to) an impedance sensor that is configured to collect electrical signal data (e.g., impedance signal or current signal) of the particles as a respective individual particle passes through the fluid channel 102. The data can be collected sequentially or concurrently.

In some embodiments, the workflow 300 includes, in step 308, enabling (e.g., facilitating) labeling of the data, and add the labeled data into a corpus of training data to train a classification algorithm. In some embodiments, labeling of the data is performed by a human subject. In some embodiments, labeling of the data is performed (e.g., automatically) by a computing device. In some embodiments, enabling labeling of the data includes annotating the data to indicate which signals correspond to which particle types.

In some embodiments, the workflow 300 includes, in step 310, storing the training data on the cloud or locally on the device.

In some embodiments, the workflow 300 includes, in step 312, preparing a sample of a new heterogeneous mixture (e.g., a fixed or predetermined volume, such as 10 microliters to 100 microliters), and repeating steps 306 and 310.

In some embodiments, the workflow 300 includes, in step 314, establishing the baseline ground truth data and iteratively updating the coarse data (e.g., obtained in step 306) to improve the accuracy of the phenotype classification. In some embodiments, the mean and standard deviation are also established from these measurements.

In some embodiments, the workflow 300 includes, in step 316, repeating the steps 302 to 310 for next precision run with electrical impedance sensing only, and applying the training algorithm in near real time to classify the particles in the sample of the new heterogeneous mixture.

In some embodiments, the workflow 300 includes, in step 318, applying de-noising filtering to the data, and repeating step 316 with different probing frequencies. In some embodiments, the de-noising filtering techniques include principal component analysis (PCA) or Bayesian analysis.

In some embodiments, the workflow 300 includes, in step 320, repeating steps 302 to 318 to improve classification speed and accuracy without going to cloud data.

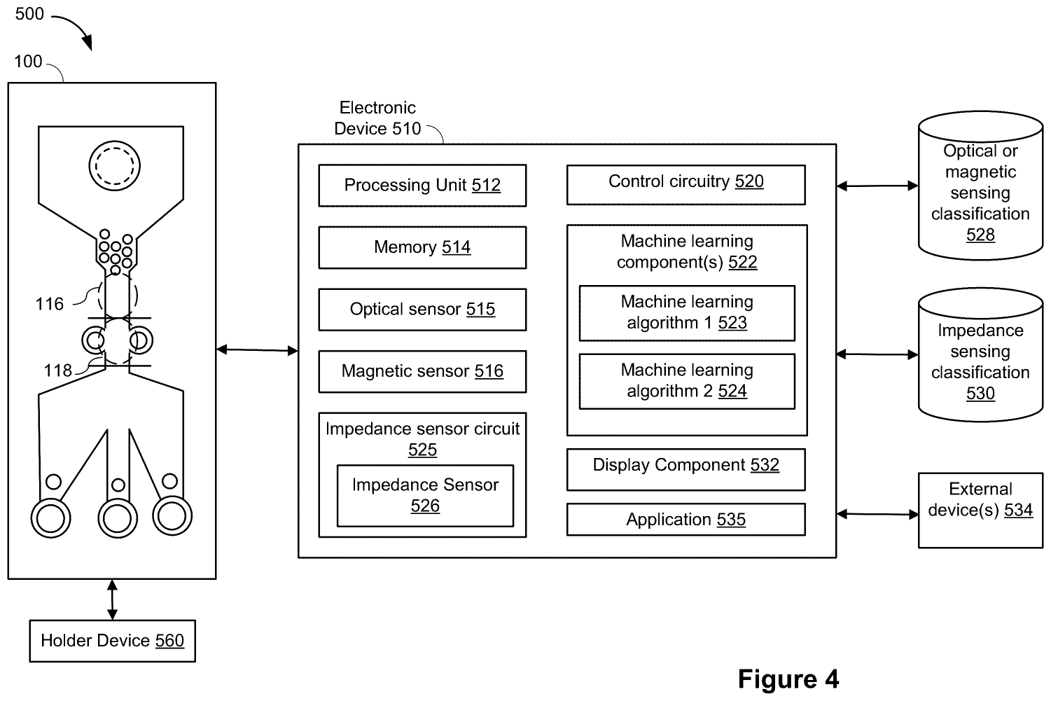

FIG. 4 is an exemplary block diagram of a system 500 for classifying individual particles, in accordance with some embodiments.

The system 500 includes a microfluidic device 100, as described with reference to FIGS. 1A, 1B, 1C, and 2. The microfluidic device 100 includes a microfluidic channel 102 arranged on a first substrate. In some embodiments, an optical or magnetic sensing zone 116 is arranged along a first portion 112 of the microfluidic channel 102. In some embodiments, an electrical sensing zone 118 is arranged along a second portion 114 of the microfluidic channel 102 (see FIG. 1C)

In some embodiments, the system 500 includes an electronic device 510 that is communicatively connected to the microfluidic device 100. The electronic device 510 includes one or more processing units 512 (e.g., processor(s) or CPU(s)) and memory 514. In some embodiments, the memory 514 stores one or more programs configured for execution by the one or more processors.

In some embodiments, the electronic device 510 includes one or more sensors that are configured to collect data from a fluidic sample (e.g., particles) of the microfluidic device 100. As shown in FIG. 4, in some embodiments, the one or more sensors can include an optical sensor 515, a magnetic sensor 516, or an impedance sensor 526. In some embodiments, the optical sensor 515 and the magnetic sensor 516 are coupled to the optical or magnetic sensing zone 116, and are configured to collect optical or magnetic data. In some embodiments, the optical sensor 515 is part of an optical microscope or a Raman microscope. In some embodiments, the impedance sensor 526 is coupled to the electrical sensing zone 118 and configured to collect impedance data. In some embodiments, the impedance data comprise a temporal series of impedance data. Details of time series impedance data are described in U.S. patent application Ser. No. 18/529,856, the contents of which are incorporated by reference herein in its entirety.

In some embodiments, the impedance sensor 526 is part of an impedance sensor circuit 525. The impedance sensor circuit 525 is configured to measure electrical impedance of particles in a fluidic sample while the particles are within the electrical sensing zone 118.

In some embodiments, the electronic device 510 includes control circuitry 520 that is communicatively coupled to the microfluidic device 100. In some embodiments, the control circuitry is part of the microfluidic device 100 (e.g., arranged on the microfluidic device 100). In some embodiments, the control circuitry is coupled to the set of piezoelectric actuators 109 and the set of electrodes 110, and configured to adjust operation of the set of piezoelectric actuators 109 and the set of electrodes 110. In some embodiments, the control circuitry 520 may comprise one or more processors (e.g., CPUs, GPUs, and/or DPUS), one or more controllers (e.g., a microcontroller), and/or other types of control circuits.

In some embodiments, the electronic device 510 includes machine learning component(s) 522 that are configured to classify particles (e.g., cells, tissue samples, and/or other types of particles) in a fluidic sample based on data from one or more of the optical or magnetic sensing zone 116 and the electrical sensing zone 118. The machine learning component(s) can comprise one or more convolutional neural networks (CNNs), one or more recurrent neural networks (RNNs), and/or one or more artificial neural networks (ANNs).

The machine learning component(s) 522 can include one or more machine learning algorithms (e.g., AI algorithms), such as a first machine learning algorithm 523 and a second machine learning algorithm 524. In some embodiments, the first machine learning algorithm 523 is configured to classify particles based on their optical and/or magnetic properties obtained by the optical sensor 515 or the magnetic sensor 516, via the optical or magnetic sensing zone 116. In some embodiments, the second machine learning algorithm 524 is configured to classify particles based on their electrical (e.g., electrical impedance) obtained by the impedance sensor 526 (or the impedance sensor circuit 525), via the electrical sensing zone 118.

In some embodiments, the electronic device 510 is communicatively coupled to one or more databases, such as an optical or magnetic sensing classification database 528 and an impedance sensing classification database 530. For example, the optical or magnetic sensing classification database 528 may store optical and magnetic data of reference samples (e.g., cells of known disease types), which can be used by the first machine learning algorithm 523 for training. The impedance sensing classification database 530 may store impedance data of reference samples (e.g., cells of known disease types), which can be used by the second machine learning algorithm 524 for training. In some embodiments, particles classification data that are generated by the electronic device 510 can be stored in the optical or magnetic sensing classification database 528 or the impedance sensing classification database 530.

In some embodiments, the electronic device 510 includes a display component 532 that enables presentation of user interfaces and display content, including one or more speakers and/or one or more visual displays.

In some embodiments, the electronic device 510 is communicatively connected to external device(s) 534 such as an external display device and an external data storage device.

In some embodiments, the display component 532 or the external device is configured to display a user interface 810 associated with an application 535 that is executed on the electronic device 510.

In some embodiments, the electronic device 510 is a microcontroller unit (MCU) that is programmed with variables for controlling the microfluidic device 100, the optical, magnetic, and/or impedance sensing, and the particles classification. In some embodiments, the electronic device 510 comprises a system-on-chip (SOC) implementation (e.g., an all-in-one unit).

In some embodiments, the electronic device 510 can include one or more input devices that facilitate user input, such as a keyboard, a mouse, a voice-command input unit or microphone, a touch screen display, a touch-sensitive input pad, a gesture capturing camera, or other input buttons or controls.

Although FIG. 4 shows an electronic device 510, FIG. 4 is intended more as a functional description of the various features that may be present rather than as a structural schematic of the embodiments described herein. In practice, and as recognized by those of ordinary skill in the art, items shown separately could be combined and some items could be separated.

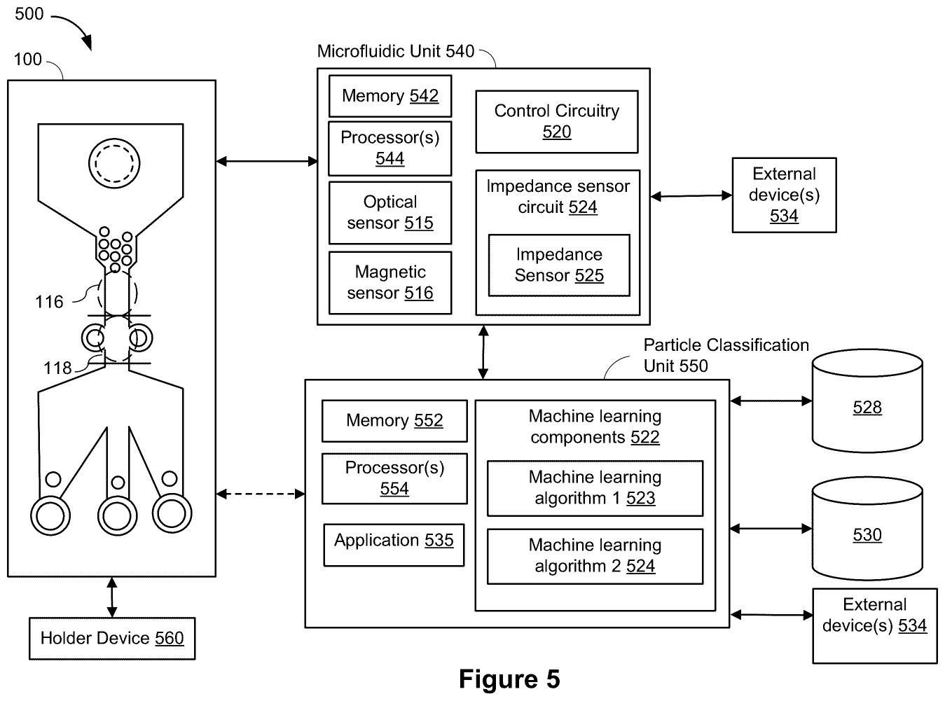

In some embodiments, the microfluidics-related functions of the electronic device 510 and the particle classification functions of the electronic device 510 can be performed by separate units, such as a microfluidic unit 540 and a particle classification unit 550, respectively, and as shown in FIG. 5. The microfluidic unit 540 includes memory 542 and processors(s) 544, and the particle classification unit 550 includes memory 552 and processor(s) 554. In some embodiments, the microfluidic unit 540 comprises a microcontroller unit (MCU). In some embodiments, the microfluidic unit 540 is a system-on-chip (SOC) implementation (e.g., an all-in-one unit). In some embodiments, the particle classification unit 550 comprises an MCU. In some embodiments, the particle classification unit 550 is a SOC implementation.

In some embodiments, the memory 514, 542, or 552 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. In some implementations, the memory 514, 542, or 552 includes one or more storage devices remotely located from one or more processing units 512, 544, or 554. The memory 514, 542, or 552, or alternatively the non-volatile memory device(s) within the memory 514, 542, or 552, includes a non-transitory computer-readable storage medium. In some implementations, the memory 514, 542, or 552 or the computer-readable storage medium of the memory 514, 542, or 552 stores the following programs, modules, and data structures that are executed by the processors (e.g., processing unit 512, processors(s) 544, processor(s) 554, and control circuitry 520) of the electronic device 510, the microfluidic unit 540, or the particle classification unit 550.

Referring again to FIGS. 4 and 5, in some embodiments, the system 500 includes a holder device 560 configured to support and electrically ground the microfluidic device 100.

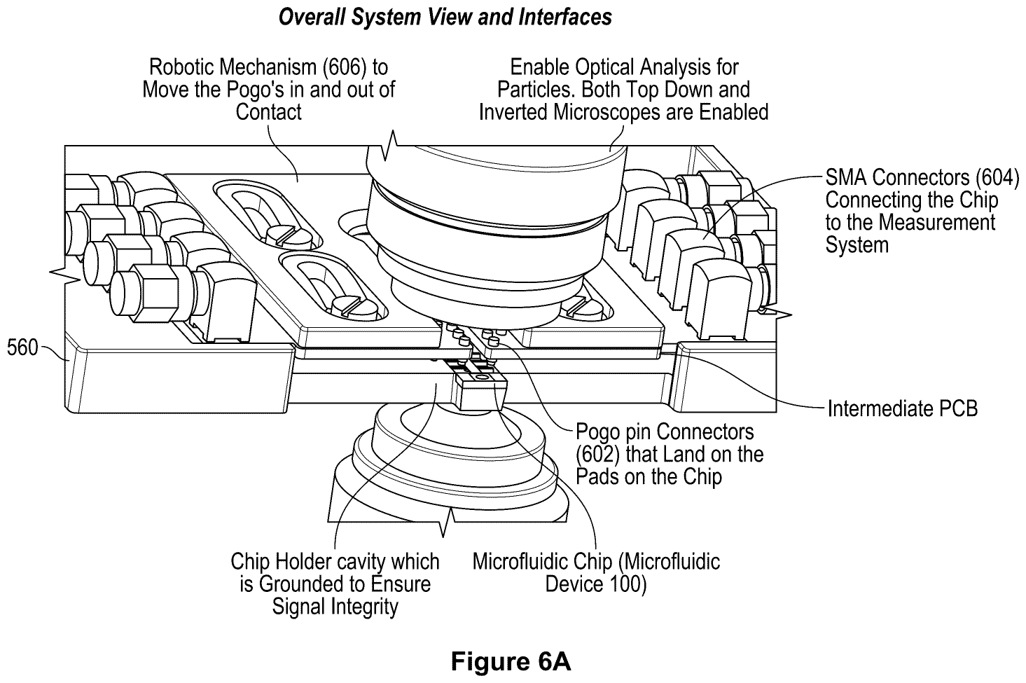

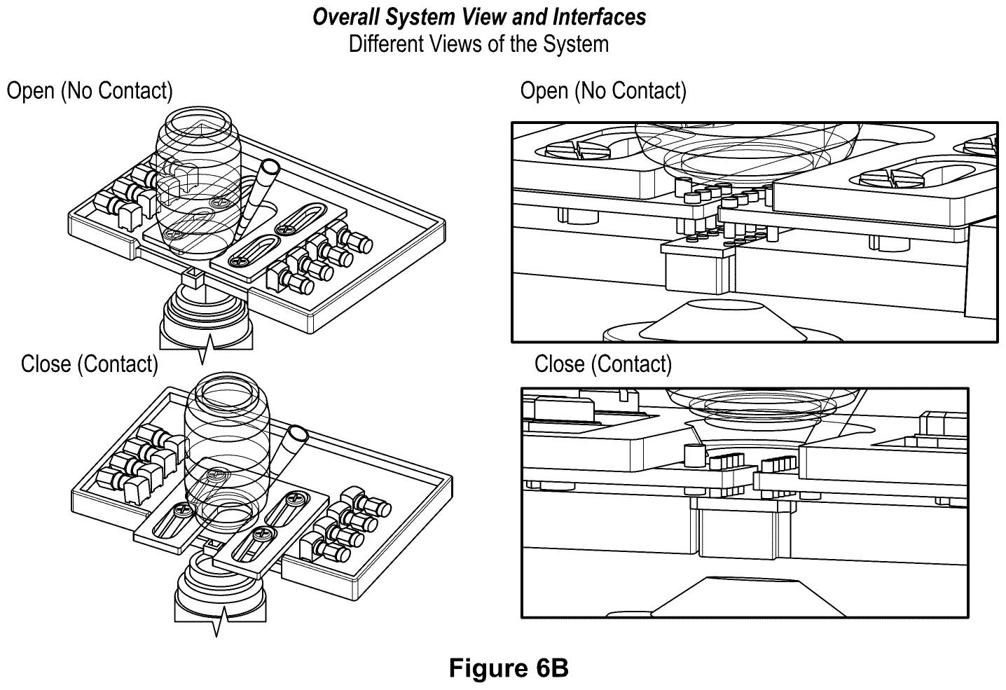

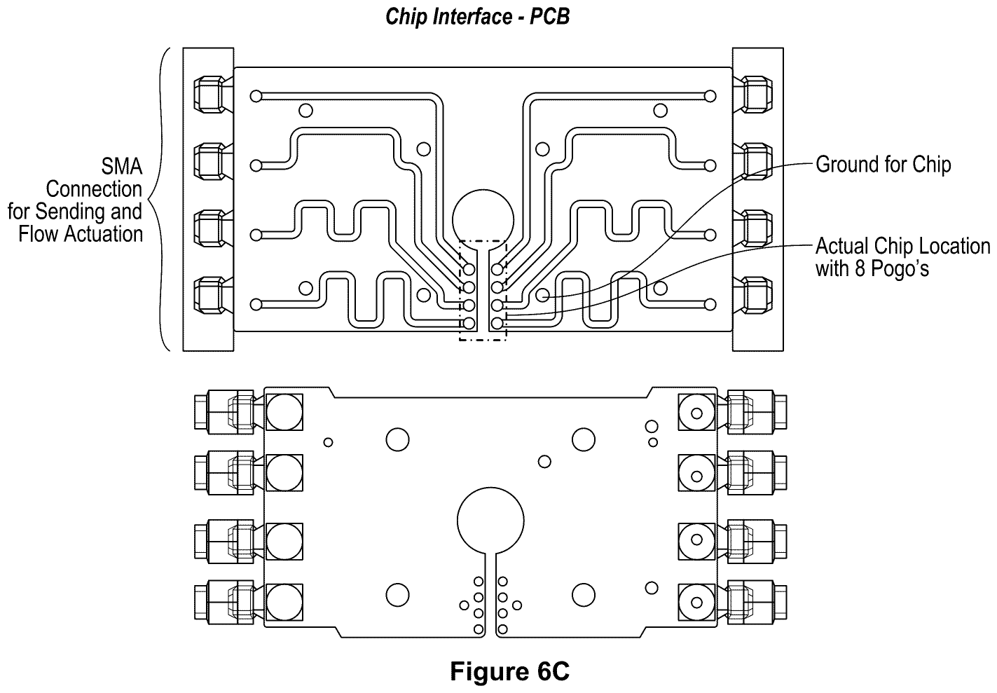

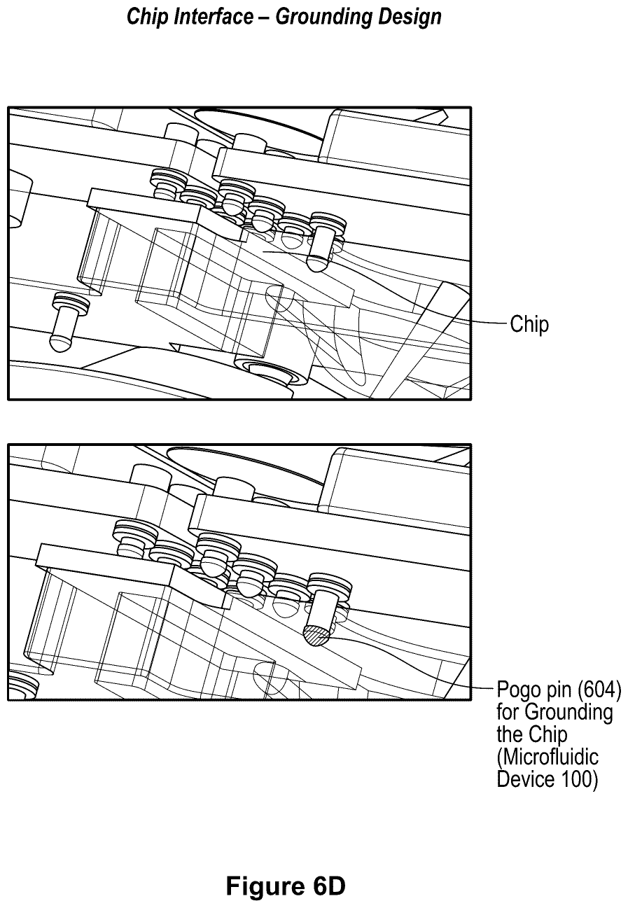

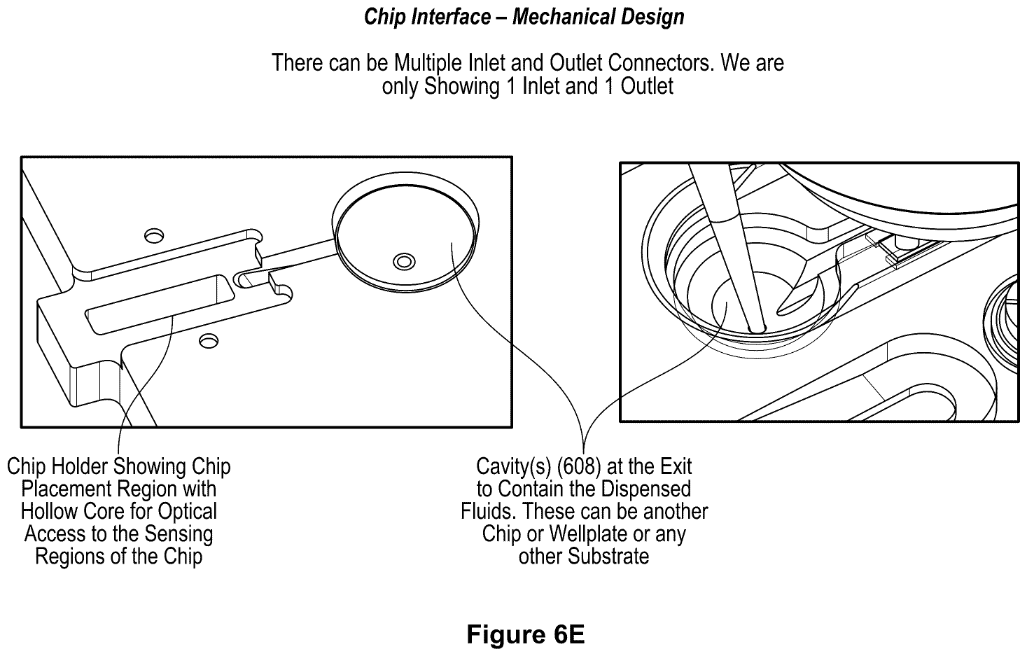

FIGS. 6A to 6E are various views of the holder device 560, in accordance with some embodiments.

In some embodiments, the holder device 560 includes pogo pin connectors 602 that are configured to couple the holder device 560 to the microfluidic device 100. For example, FIG. 6A shows that the pogo pin connectors 602 contact respective pads of the microfluidic device 100) In some embodiments, at least one of the one or more of the pogo pin connectors 602 is connected to an electrical ground, as illustrated in FIG. 6D. In some embodiments, the holder device 560 includes one or more connectors 604 (e.g., SubMiniature version A (SMA) connectors) that couple sensing circuitry (e.g., optical sensor 515, magnetic sensor 516, impedance sensor 526, impedance sensor circuit 525, control circuitry 520) to the optical or magnetic sensing zone 116 and/or the electrical sensing zone 118.

As illustrated in FIG. 6A, in some embodiments, the holder device 560 further comprises a robotic mechanism 606 (e.g., an actuator mechanism) configured to selectively couple the one or more pogo pin connectors 602 to the microfluidic device 100. FIG. 6E shows that, in some embodiments, the holder device 560 is shaped to have a cavity 608 at a portion corresponding to the optical or magnetic sensing zone 116.

In some embodiments, the optical sensor 515 is positioned to sense particles of a fluidic sample via the cavity 608. In some embodiments, the optical sensor 515 is part of an optical microscope or a Raman microscope. In some embodiments, the holder device 560 includes one or more inlet cavities and one or more outlet cavities that align with respective inlets and outlets of the microfluidic device 100 while the microfluidic device is mounted on the holder device 560.

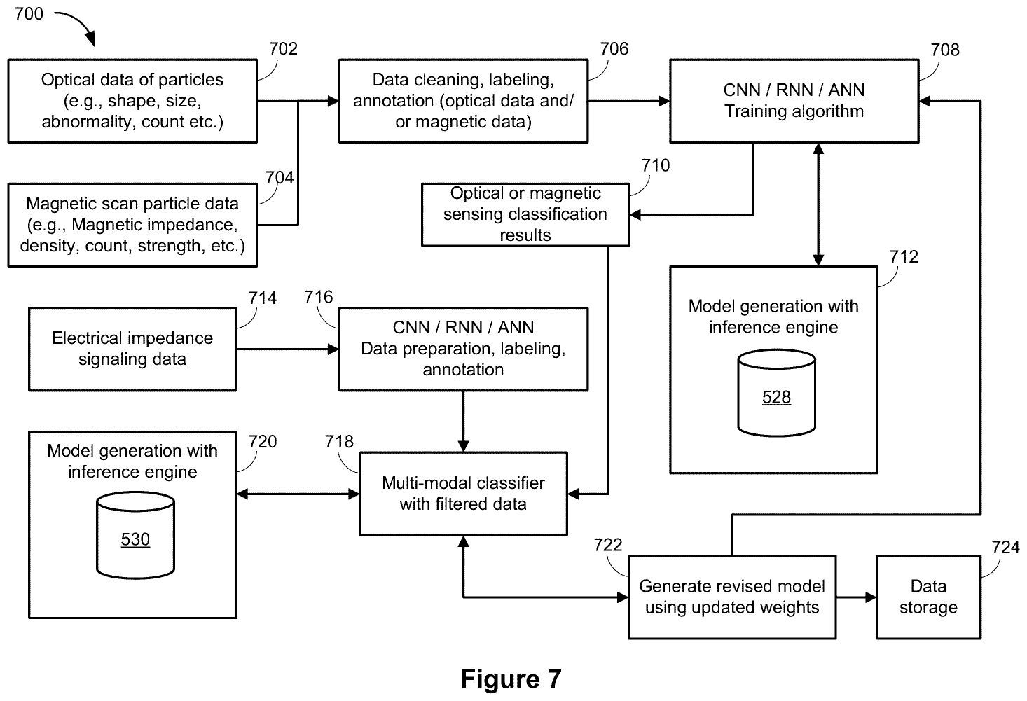

FIG. 7 illustrates a process 700 for classifying particles, in accordance with some embodiments. The process 700 includes obtaining (702) optical data of particles (e.g., individual cells, tissue samples, and/or other types of particles). In some embodiments, the optical data include imaging data. For example, the optical data of the particles can include a shape, size, abnormality, or count of the particles. In some embodiments, the process 700 includes obtaining (704) magnetic data of particles. The magnetic data can include magnetic impedance, magnetic flux density, magnetic strength, or count of the particles. The process includes cleaning, enabling labeling, and/or annotating (706) the optical data and the magnetic data to generate labeled optical data and labeled magnetic data.

In some embodiments, the labeled optical and magnetic data are used as inputs to train (708) a machine learning algorithm. In some embodiments, the machine learning algorithm can comprise one or more CNNs, RNNs, and/or ANNs. The machine learning algorithm outputs a respective classification (e.g., a disease type, a phenotype) for a respective particle based on the optical or magnetic sensing data (step 710). The labeled optical data and labeled magnetic data, which may include information identifying a particle type (e.g., a disease type) for a respective particle, include ground truth of the respective particle. Training the machine learning algorithm using the labeled data enables the algorithm to recognize features corresponding to particular cell types or disease types, thereby improving performance of the algorithm. Availability of the ground truth enables partially supervised learning to be performed.

With continued reference to FIG. 7, the process 700 includes obtaining (714) electrical impedance data of particles, and preparing, labeling, and/or annotating (716) the electrical impedance data, to obtain labeled impedance data. In some embodiments, step 716 is performed by a machine learning model (e.g., a CNN, RNN, or CNN).

In some embodiments the labeled impedance data (from step 716) and the optical or magnetic sensing classification results (from step 710) are used as inputs to train a multi-modal classifier (step 718). The multi-modal classifier is configured to classify particles according to particle data acquired using various modalities (e.g., optical data of particles acquired using an optical mode, magnetic data of particles acquired using a magnetic mode, and electrical impedance data of particles acquired using an electrical mode). In some embodiments, prior to training the multi-modal classifier, the impedance data are processed by applying a de-noising filter (e.g., principal component analysis (PCA) or Bayesian analysis) to generate filtered impedance data, which are used for training the multi-modal classifier.

In some embodiments, the output of the multi-modal classifier is used to generate an updated model (step 720) that uses an inference engine to process new impedance data of particles (e.g., that are stored in the impedance sensing classification database 530) to generate particle classification results according to the impedance data.

In some embodiments, the output of the multi-modal classifier is used to adjust one or more model parameters (e.g., weights, biases, or activation functions) of the training algorithm (step 722), and to generate an updated model (step 712) that uses an inference engine to process new optical or magnetic data (e.g., that are stored in the optical or magnetic sensing classification database 528) to generate particle classification results according to the optical or magnetic data.

In some embodiments, the process 700 includes storing data (step 724), such as the updated model, the model parameters, or the particle type classifications. In some embodiments, the data are stored locally on the system 500 (e.g., on the electronic device 510, the microfluidic unit 540, or the particle classification unit 550). In some embodiments, the data are stored externally on external device(s) 534.

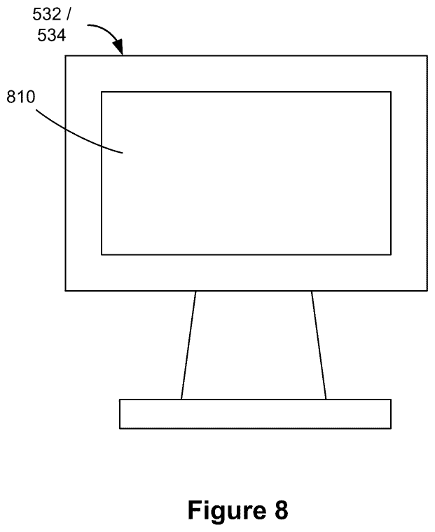

FIG. 8 illustrates a user interface 810 of an entropy optimization engine application (e.g., application 535) that is displayed on a display component 532 or an external display device 534, in accordance with some embodiments. In some embodiments, the entropy optimization engine application is configured to implement cell classification algorithms (e.g., machine learning algorithm 523 or 524, classifier 718) to determine a respective particle type classification for particle samples, the user interface 810 facilitates visualizations of respective particle types.

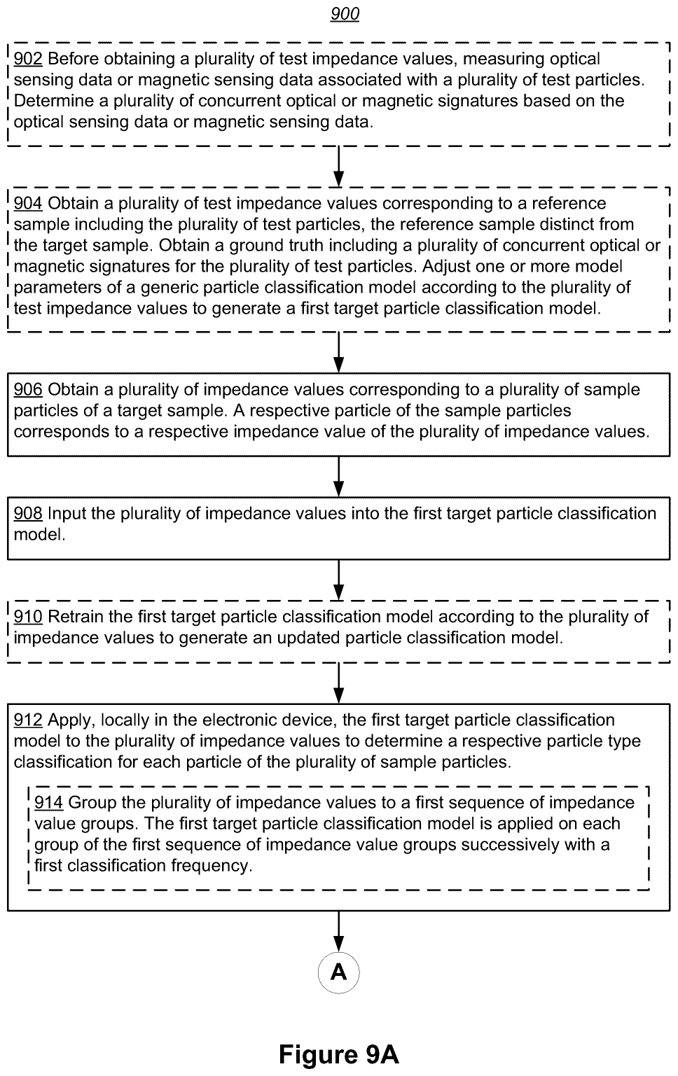

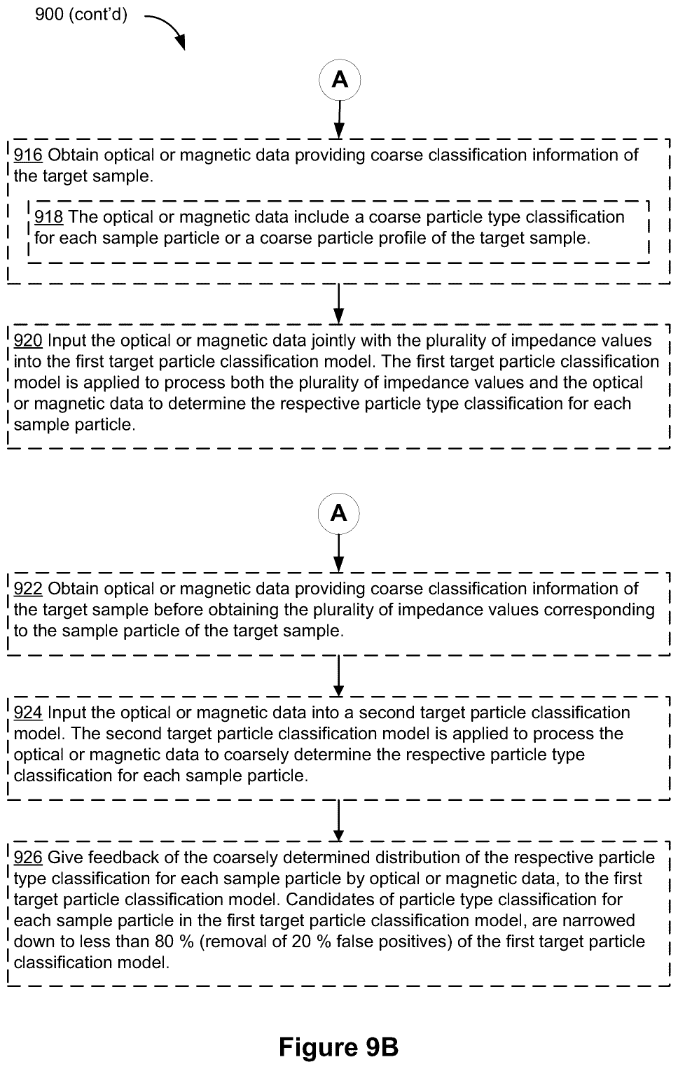

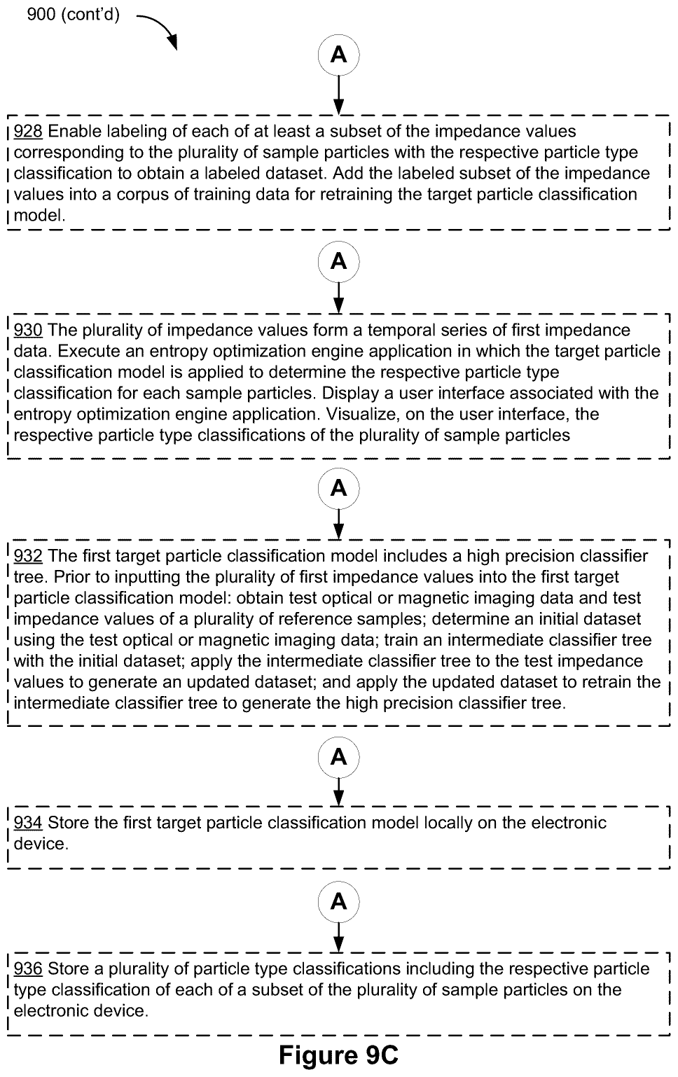

FIGS. 9A to 9C provide a flowchart of an example process for classifying individual particles, in accordance with some embodiments. The method 900 is performed at a system (e.g., system 500) that includes a microfluidic device (e.g., microfluidic device 100) and an electronic device (e.g., electronic device 510, microfluidic unit 540, particle classification unit 550). The microfluidic device 100 includes a microfluidic channel 102 arranged on a first substrate, an optical or magnetic sensing zone 116 arranged along a first portion 112 of the microfluidic channel 102, and an electrical sensing zone 118 arranged along a second portion 114 of the microfluidic channel 102. The electronic device includes one or more processors (e.g., processing unit 512, processor(s) 544), processor(s) 554), and memory (e.g., memory 514, memory 542, memory 552) storing one or more programs configured for execution by the one or more processors. In some embodiments, the electronic device is a microcontroller unit (MCU). In some embodiments, the method 900 is performed using an application (e.g., application 535, or a program, or other executable instructions). In some embodiments, the memory stores one or more programs configured for execution by the one or more processors. In some embodiments, the operations shown in FIGS. 1A to IC, 2, 3, 6A to 6E, 7, and 8 correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 900 may be combined and/or the order of some operations may be changed.

In some embodiments, the system 500, before obtaining a plurality of test impedance values, measures (902) optical sensing data or magnetic sensing data associated with the plurality of test particles. In some embodiments, the system measures the optical sensing data or magnetic sensing data using an optical sensor 515 or a magnetic sensor 516, while the particles are in the optical or magnetic sensing zone 116 of the microfluidic device 100. The system determines a plurality of concurrent optical or magnetic signatures based on the optical sensing data or magnetic sensing data.

In some embodiments, the system 500 obtains (904) a plurality of test impedance values corresponding to a reference sample including a plurality of test particles, the reference sample distinct from a target sample. For example, in some embodiments, the system 500 obtains the plurality of test impedance values by measuring the impedance values of the test particles using an impedance sensor 525 while the test particles are in the electrical sensing zone 118 of the microfluidic device 100. In some embodiments, the system 500 obtains the plurality of test impedance values from a database such as the impedance sensing classification database 530.

The system 500 obtains a ground truth including a plurality of concurrent optical or magnetic signatures for the plurality of test particles. The system 500 adjusts (e.g., in real-time or near real time) one or more model parameters (e.g., weights, biases, or activation functions) of a generic particle classification model (e.g., training algorithm 708, FIG. 7) according to the plurality of test impedance values to generate a first target particle classification model (e.g., updated model in step 712 or updated model in step 720, FIG. 7). In some embodiments, adjusting the one or more model parameters of the generic particle classification model leads to a reduction in noise and an amplification of signals. In some embodiments, compared to the generic particle classification model, the signal-to-noise ratio of the first target particle classification model is enhanced.

The system 500 obtains (906) a plurality of impedance values corresponding to a sample particle of a target sample. A respective particle of the sample particles corresponds to a respective impedance value of the plurality of impedance values.

The system 500 inputs (908) the plurality of impedance values into the first target particle classification model.

In some embodiments, after inputting the plurality of impedance values into the target particle classification model, the system 500 retrains (910) the target particle classification model according to the plurality of impedance values to generate an updated particle classification model.

The system 500 applies (912), locally in the electronic device, the first target particle classification model to the plurality of impedance values to determine a respective particle type classification for each particle of the plurality of sample particles.

In some embodiments, the system 500 groups (914) the plurality of impedance values to a first sequence of impedance value groups. The target particle classification model is applied on each group of the first sequence of impedance value groups successively with a first classification frequency.

Referring to FIG. 9B, in some embodiments, the system 500 obtains (916) optical or magnetic data providing coarse classification information of the target sample.

In some embodiments, the optical or magnetic data include (918) a coarse particle type classification for each sample particle or a coarse particle profile of the target sample.

In some embodiments, the system 500 inputs (920) the optical or magnetic data jointly with the plurality of impedance values into the first target particle classification model. The first target particle classification model is applied to process both the plurality of impedance values and the optical or magnetic data to determine the respective particle type classification for each sample particle.

In some embodiments, the system 500 obtains (922) optical or magnetic data providing coarse classification information of the target sample before obtaining the plurality of impedance values corresponding to the sample particle of the target sample. In some embodiments, the system 500 inputs (924) the optical or magnetic data into a second target particle classification model. The second target particle classification model is applied to process the optical or magnetic data to coarsely determine the respective particle type classification for each sample particle.

In some embodiments, the system 500 gives (926) feedback of the coarsely determined distribution of the respective particle type classification for each sample particle by optical or magnetic data, to the first target particle classification model. Candidates of particle type classification for each sample particle in the first target particle classification model, are narrowed down to less than 80% (e.g., removal of 20% false positives) of the first target particle classification model.

With continued reference to FIG. 9C, in some embodiments, the system 500 enables (928) labeling of each of at least a subset of the impedance values corresponding to the plurality of sample particles with the respective particle type classification to obtain a labeled dataset. The system 500 adds the labeled subset of the impedance values into a corpus of training data for retraining the target particle classification model.

In some embodiments, the plurality of impedance values form a temporal series of first impedance data. In some embodiments, the system 500 executes (930) an entropy optimization engine application in which the target particle classification model is applied to determine the respective particle type classification for each sample particles. In some embodiments, the system displays a user interface (e.g., user interface 810) associated with the entropy optimization engine application, and visualizes on the user interface, the respective particle type classifications of the plurality of sample particles.

In some embodiments, the target particle classification model includes (932) a high precision classifier tree. Prior to inputting the plurality of first impedance values into the target particle classification model, the system 500 obtains test optical or magnetic imaging data and test impedance values of a plurality of reference samples (e.g., the reference samples are particles with known disease types). The system 500 determines an initial dataset using the test optical or magnetic imaging data. The system 500 trains an intermediate classifier tree with the initial dataset. The system 500 applies the intermediate classifier tree to the test impedance values to generate an updated dataset. The system 500 applies the updated dataset to retrain the intermediate classifier tree to generate the high precision classifier tree.

In some embodiments, the system 500 stores (934) the target particle classification model locally on the electronic device.

In some embodiments, the system 500 stores (936) a plurality of particle type classifications including the respective particle type classification of each of a subset of the plurality of sample particles on the electronic device.

The microfluidic devices described herein allow for electrical and/or optical sensing of one or more cells (or other particles). The microfluidic aspect of the devices allows for precise flow control (e.g., using electrodes, MEMS sensors, and/or piezoelectric components). Additionally, the piezoelectric layer allows for additional integrated functions such as cell sorting (e.g., after the cell signatures are captured). In some embodiments where the substrate is composed of silicon (e.g., the second substrate portion), the electrodes are deposited (e.g., in various aspect ratios) in proximity to one another (e.g., allowing handling various sample types and sample heterogeneity). The piezoelectric component (e.g., a MEMS piezoelectric layer) having an outlet port (e.g., a nozzle) allows direct ejection (e.g., jetting) of cells (e.g., after they have been processed).

Turning on to some example embodiments:

(A1) In accordance with some embodiments, a system for classifying individual particles comprises a microfluidic device having a microfluidic channel arranged on a substrate; an optical or magnetic sensing zone arranged along a first portion of the microfluidic channel; and an electrical sensing zone arranged along a second portion of the microfluidic channel. The system comprises an electronic device having one or more processors and memory. The memory stores one or more programs configured for execution by the one or more processors. The one or more programs include instructions for: obtaining a plurality of impedance values corresponding to a plurality of sample particles of a target sample, wherein a respective particle of the sample particles corresponds to a respective impedance value of the plurality of impedance values; inputting the plurality of impedance values into a first target particle classification model; and applying, locally in the electronic device, the first target particle classification model to the plurality of impedance values to determine a respective particle type classification for each particle of the plurality of sample particles.

(A2) In some embodiments of A1, the one or more programs further includes instructions for: obtaining optical or magnetic data providing coarse classification information of the target sample; and inputting the optical or magnetic data jointly with the plurality of impedance values into the first target particle classification model. The first target particle classification model is applied to process both the plurality of impedance values and the optical or magnetic data to determine the respective particle type classification for each sample particle.

(A3) In some embodiments of A2, the optical or magnetic data include a coarse particle type classification for each sample particle or a coarse particle profile of the target sample.

(A4) In some embodiments of any of A1-A3, the one or more programs further include instructions for: obtaining optical or magnetic data providing coarse classification information of the target sample before obtaining the plurality of impedance values corresponding to the sample particle of the target sample; and inputting the optical or magnetic data into a second target particle classification model. The second target particle classification model is applied to process the optical or magnetic data to coarsely determine the respective particle type classification for each sample particle.

(A5) In some embodiments of A4, the one or more programs further include instructions for: giving feedback of the coarsely determined respective particle type classification of the respective particle type classification for each sample particle by optical or magnetic data, to the first target particle classification model. Candidates of particle type classification for each sample particle in the first target particle classification model, are narrowed down to less than 80% (removal of 20% false positives) of the first target particle classification model.

(A6) In some embodiments of any of A1-A5, the one or more programs further include instructions for: enabling labeling of each of at least a subset of the impedance values corresponding to the plurality of sample particles with the respective particle type classification; and adding the labeled subset of the impedance values into a corpus of training data for retraining the target particle classification model.

(A7) In some embodiments of any of A1-A6, the plurality of impedance values form a temporal series of first impedance data. The one or more programs further include instructions for: executing an entropy optimization engine application in which the target particle classification model is applied to determine the respective particle type classification for each sample particles; displaying a user interface associated with the entropy optimization engine application; and visualizing, on the user interface, the respective particle type classifications of the plurality of sample particles.

(A8) In some embodiments of any of A1-A7, the one or more programs further include instructions for: prior to inputting the plurality of impedance values into the target particle classification model: obtaining a plurality of test impedance values corresponding to a reference sample including a plurality of test particles, the reference sample distinct from the target sample; obtaining a ground truth including a plurality of concurrent optical or magnetic signatures for the plurality of test particles; and adjusting one or more model parameters of a generic particle classification model according to the plurality of test impedance values to generate the target particle classification model.

(A9) In some embodiments of A8, the one or more programs further include instructions for: before obtaining the plurality of test impedance values, measuring optical sensing data or magnetic sensing data associated with the plurality of test particles; and determining the plurality of concurrent optical or magnetic signatures based on the optical sensing data or magnetic sensing data.

(A10) In some embodiments of any of A1-A9, the target particle classification model includes a high precision classifier tree. The one or more programs further include instructions for: prior to inputting the plurality of impedance values into the target particle classification model: obtaining test optical or magnetic imaging data and test impedance values of a plurality of reference samples; determining an initial dataset using the test optical or magnetic imaging data; training an intermediate classifier tree with the initial dataset; applying the intermediate classifier tree to the test impedance values to generate an updated dataset; and applying the updated dataset to retrain the intermediate classifier tree to generate the high precision classifier tree.

(A11) In some embodiments of any of A1-A10, the one or more programs further include instructions for: grouping the plurality of impedance values to a first sequence of impedance value groups, wherein the target particle classification model is applied on each group of the first sequence of impedance value groups successively with a first classification frequency.

(A12) In some embodiments of any of A1-A11, the one or more programs further include instructions for: after inputting the plurality of impedance values into the target particle classification model, retraining the target particle classification model according to the plurality of impedance values to generate an updated particle classification model.

(A13) In some embodiments of any of A1-A12, the one or more programs further include instructions for storing the target particle classification model locally on the electronic device.

(A14) In some embodiments of any of A1-A13, the one or more programs further include instructions for: storing a plurality of particle type classifications including the respective particle type classification of each of a subset of the plurality of sample particles on the electronic device.

(B1) In accordance with some embodiments, a microfluidic device comprises a microfluidic channel arranged on a substrate; an optical sensing zone arranged along a first portion of the microfluidic channel; and an electrical sensing zone arranged along a second portion of the microfluidic channel. The electrical sensing zone includes a set of electrodes and a set of piezoelectric actuators.

(B2) In some embodiments of B1, the microfluidic device further comprising comprises circuitry coupled to the set of piezoelectric actuators and the set of electrodes. The control circuitry is configured to adjust operation of the set of piezoelectric actuators and the set of electrodes.

(B3) In some embodiments of B2, the control circuitry comprises one or more machine learning components. The one or more machine learning components are configured to classify particles in a fluidic sample based on data from one or more of the optical sensing zone and the electrical sensing zone.

(B4) In some embodiments of any of B1-B3, the set of piezoelectric actuators are configured to cause manipulation of a particle while the particle is in the electrical sensing zone.

(B5) In some embodiments of any of B1-B4, the microfluidic channel is formed by coupling the substrate with a second substrate via a bonding layer.

(B6) In some embodiments of B5, at least a portion of the second substrate is at least partially transparent such that optical sensing in the optical sensing zone is performed through the second substrate.

(C1) In accordance with some embodiments, a microfluidic measurement system comprises a microfluidic device. The microfluidic device includes a microfluidic channel arranged on a substrate; an optical sensing zone arranged along a first portion of the microfluidic channel; and an electrical sensing zone arranged along a second portion of the microfluidic channel. The electrical sensing zone includes a set of (e.g., one or more) electrodes and a set of (e.g., one or more) piezoelectric actuators. In some embodiments, the microfluidic device includes one or more inlets coupled to the microfluidic channel (e.g., upstream of the optical sensing zone and the electrical sensing zone) and one or more outlets (e.g., downstream from the optical sensing zone and the electrical sensing zone) coupled to the microfluidic channel.

(C2) In some embodiments of C1, the microfluidic measurement system of further comprises control circuitry coupled to the set of piezoelectric actuators and the set of electrodes. The control circuitry is configured to adjust operation of the set of piezoelectric actuators and the set of electrodes. For example, the control circuitry may comprise one or more processors (e.g., CPUs, GPUs, and/or DPUS), one or more controllers (e.g., a microcontroller), and/or other types of control circuits. In some embodiments, the control circuitry is arranged on the microfluidic device. In some embodiments, the control circuitry is communicatively coupled to the microfluidic device.

(C3) In some embodiments of C1 or C2, the control circuitry comprises one or more machine learning components. The one or more machine learning components are configured to classify particles (e.g., cells, tissue samples, and/or other types of particles) in a fluidic sample based on data from one or more of the optical sensing zone and the electrical sensing zone. In some embodiments, the one or more machine learning components comprise a first component coupled to the optical sensing zone and configured to classify particles based on optical and/or magnetic properties (e.g., shape, size, abnormality, count, magnetic impedance, magnetic density, and/or magnetic strength). In some embodiments, the one or more machine learning components comprise a second component coupled to the electrical sensing zone and configured to classify particles based on electrical (e.g., electrical impedance) properties. In some embodiments, the one or more machine learning components comprise one or more convolutional neural networks (CNNs), one or more recurrent neural networks (RNNs), and/or one or more artificial neural networks ANNs).

(C4) In some embodiments of any of C1-C3, the microfluidic measurement system further comprises an impedance sensor circuit coupled to the electrical sensing zone. The impedance sensor circuit is configured to measure electrical impedance of particles in a fluidic sample while the particles are within the electrical sensing zone.

(C5) In some embodiments of any of C1-C4, the microfluidic measurement system further comprises a holder device configured to support and electrically ground the microfluidic device.

(C6) In some embodiments of C5, the holder device comprises one or more pin connectors (e.g., pogo pin connectors that contact respective pads of the microfluidic device) configured to couple the holder to the microfluidic device. In some embodiments, at least one of the one or more pin connectors is connected to an electrical ground. In some embodiments, the holder device further comprises one or more connectors coupling sensing circuitry to the optical sensing zone and/or the electrical sensing zone.

(C7) In some embodiments of C6, the holder device further comprises an actuator mechanism configured to selectively couple the one or more pin connectors to the microfluidic device.

(C8) In some embodiments of any of C5-C7, the holder device is shaped to have a cavity at a portion corresponding to the optical sensing zone. The microfluidic measurement system further comprises an optical sensor positioned to sense particles of a fluidic sample via the cavity. For example, in some embodiments, the optical sensor comprises a microscope (e.g., is part of a microscope, such as an optical microscope or a Raman microscope). In some embodiments, the holder device includes one or more inlet cavities and one or more outlet cavities that align with respective inlets and outlets of the microfluidic device while the microfluidic device is mounted on the holder device.

(C9) In some embodiments of any of C1-C8, the set of piezoelectric actuators are configured to cause manipulation of a particle while the particle is in the electrical sensing zone.

(C10) In some embodiments of any of C1-C9, the set of electrodes are configured to apply an electric field to a particle in the electrical sensing zone.

(C11) In some embodiments of any of C1-C10, the microfluidic channel is formed by coupling the substrate with a second substrate via a bonding layer. In some embodiments, the substrate is composed of silicon (e.g., is a silicon or silicon-on-insulator substrate). In some embodiments, the second substrate is composed of glass or plastic material. In some embodiments, the bonding layer comprises a polymer layer.

(C12) In some embodiments of C11, at least a portion of the second substrate is at least partially transparent such that optical sensing in the optical sensing zone is performed through the second substrate.

(C13) In some embodiments of any of C1-C12, the microfluidic measurement system further comprises comprising a storage device (e.g., a remote storage device such as a cloud-based or server-based storage).

(C14) In some embodiments of any of C1-C13, the microfluidic measurement system further comprises a second set of piezoelectric actuators configured to control a flow rate of a fluidic sample.

(D1) In accordance with some embodiments, a method for classifying individual particles is performed at an electronic device having one or more processors, and memory storing one or more programs configured for execution by the one or more processors. In some embodiments, the electronic device is microcontroller unit (MCU). The method includes obtaining a plurality of first impedance values (e.g., impedance data values; electrical impedance signaling values) corresponding to a plurality of sample particles of a target sample. Each particle of the plurality of sample particles corresponds to a respective impedance value of the plurality of first impedance values. In some embodiments, there is a one-to-one correspondence between particle and impedance value. The method includes inputting the plurality of first impedance values into a target particle classification model. The method includes, applying, locally in the electronic device, the target particle classification model to the plurality of first impedance values to determine a respective particle type classification for each particle of the plurality of sample particles.

(D2) In some embodiments of D1, the method includes obtaining optical or magnetic data providing coarse classification information of the target sample; and inputting the optical or magnetic data jointly with the plurality of first impedance values into the target particle classification model. The target particle classification model is applied to process both the plurality of first impedance values and the optical or magnetic data to determine the respective particle type classification for each sample particle. In some embodiments, the coarse classification information includes 2D morphology of the particles, particle topography, cell deformities, etc. Fine classification information comprises impedance data.

(D3) In some embodiments of D2, the optical or magnetic data include a coarse particle type classification for each sample particle or a coarse particle profile of the target sample.

(D4) In some embodiments of D3, the optical or magnetic data include a coarse particle type classification for a first sample particle, and the coarse particle type classification corresponds to a first set of particle types. The respective particle type classification of the first sample particle, which is determined based on a respective first impedance value, corresponds to a second set of particle types. The first set of particle types include the second set of particle types.

(D5) In some embodiments of any of D2-D4, the optical or magnetic data are generated by an alternative classification model. The method further comprises providing the respective particle type classification for each sample particle of at least a subset of sample particles to train the alternative classification model.

(D6) In some embodiments of any of D1-D5, the electronic device includes a microfluidic channel and is coupled to an optical sensor system. The method further comprises, for a first sample particle: while the first sample particle is located in a first channel portion of the microfluidic channel, measuring an optical signal by the optical sensor and generating optical data of the first sample particle based on the optical signal.

(D7) In some embodiments of D6, the electronic device includes an impedance sensor. The method includes, for the first sample particle, after measuring the optical signal, while the first sample particle is located in a second channel portion of the microfluidic channel, measuring an impedance signal by the impedance sensor; and generating a respective first impedance value of the first sample particle based on the impedance signal.

(D8) In some embodiments of D7, the second channel portion is coupled downstream to the first channel portion on a particle path of each particle of the plurality of sample particles.

(D9) In some embodiments of D7 or D8, the method includes inputting the optical data and the respective first impedance value of the first sample particle into the target particle classification model, wherein the target particle classification model is applied to determine the respective particle type classification for the first sample particle.

(D10) In some embodiments of any of D1-D9, the plurality of first impedance values form a temporal series of first impedance data. The method includes executing an entropy engine application in which the target particle classification model is applied to determine the respective particle type classification for each sample particle; displaying a user interface associated with the entropy engine application; and visualizing, on the user interface, the respective particle type classifications of the plurality of sample particles.

(D11) In some embodiments of any of D1-D10, the method includes, prior to inputting the plurality of first impedance values into the target particle classification model: obtaining a plurality of test impedance values corresponding to a reference sample including a plurality of test particles. The reference sample is distinct from the target sample. In some embodiments, the reference sample used for noise suppression, noise reduction, signal amplification, or signal-to-noise ratio enhancement. The method includes obtaining a ground truth including a plurality of concurrent optical or magnetic signatures for the plurality of test particles. The method includes adjusting (e.g., refining or modifying, in real time or near real time) one or more model parameters (e.g., weights, biases, activation functions) of a generic particle classification model according to the plurality of test impedance values to generate the target particle classification model.

(D12) In some embodiments of D11, the method includes determining at least one of a mean and a standard deviation of the plurality of test impedance values.

(D13) In some embodiments of D11 or D12, the method includes, before obtaining the plurality of test impedance values, measuring optical sensing data or magnetic sensing data associated with the plurality of test particles; and determining the plurality of concurrent optical or magnetic signatures based on the optical sensing data or magnetic sensing data.

(D14) In some embodiments of D13, the optical sensing data of the plurality of test particles include one or more of: particle shapes, particle sizes, abnormalities, and a count of a subset of test particles.

(D15) In some embodiments of D13 or D14, the magnetic sensing data of the plurality of test particles include one or more of: a magnetic impedance, a density, a count, and a strength of a subset of test particles.

(D16) In some embodiments of any of D1-D15, the target particle classification model includes a high precision classifier tree. The method includes, prior to inputting the plurality of first impedance values into the target particle classification model: obtaining test optical or magnetic imaging data and test impedance values of a plurality of reference samples (e.g., the reference samples may be cancer cells with known cancer types). The method includes determining an initial dataset using the test optical or magnetic imaging data; training an intermediate classifier tree with the initial dataset; applying the intermediate classifier tree to the test impedance values to generate an updated dataset; and applying the updated dataset to retrain the intermediate classifier tree to generate the high precision classifier tree.

(D17) In some embodiments of any of D1-D16, the method includes grouping the plurality of first impedance values to a first sequence of impedance value groups. The target particle classification model is applied on each group of the first sequence of first impedance value groups successively with a first classification frequency.

(D18) In some embodiments of any of D1-D17, the method includes applying a de-noising filter to the plurality of first impedance values to generate filtered first impedance values; and grouping the filtered first impedance values to a second sequence of impedance value groups. The target particle classification model is applied on each group of the second sequence of impedance value groups successively with a second classification frequency.

(D19) In some embodiments of D18, applying the de-noising filter comprises applying principal component analysis (PCA) or Bayesian analysis.

(D20) In some embodiments of any of D1-D19, the method includes after inputting the plurality of first impedance values into the target particle classification model, retraining the target particle classification model according to the plurality of first impedance values (e.g., via a generative adversarial network) to generate an updated particle classification model.

(D21) In some embodiments of any of D1-D20, the method includes storing the target particle classification model locally on the electronic device. In some embodiments, the plurality of sample particles is a heterogeneous mixture of particles with unknown particle types. In some embodiments, the plurality of sample particles re obtained from a tissue sample.

(D22) In some embodiments of any of D1-D21, the method includes storing a plurality of particle type classifications including the respective particle type classification of each of a subset of the plurality of sample particles on the electronic device.

(D23) In some embodiments of any of D1-D22, the method includes enabling labeling (e.g., facilitating labeling, such as annotating which impedance values correspond to which particle types) of each of at least a subset of first impedance values corresponding to the plurality of sample particles with the respective particle type classification; and adding the labeled subset of first impedance values into a corpus of training data for retraining the target particle classification model. In some embodiments, the retraining is performed on the electronic device. In some embodiments, the training is performed on a computer system that is communicatively connected to the electronic device; In some embodiments, the retraining is performed on a server system (e.g., on the cloud) that is communicatively connected to the electronic device.

(D24) In some embodiments of any of D1-D23, the method includes, prior to the obtaining, training an initial particle classification model based on a corpus of training data comprising data from particles having one or more known particle types to generate the target particle classification model.

In some embodiments, the corpus of training data include impedance values corresponding to at least 25 distinct types of diseased particles, at least 50 distinct types of diseased particles, at least 100 distinct types of diseased particles, at least 200 distinct types of diseased particles, at least 250 distinct types of diseased particles, or at least 300 distinct types of diseased particles or distinct types of diseased particles. In some embodiments, initial particle classification model, when trained, forms a generic particle classification model. In some embodiments, the generic particle classification model is retrained to generate the target particle classification model.

(D25) In some embodiments of D24, the initial particle classification model is trained via a computer system that is different from the electronic device (e.g., the computer system is communicatively connected with the electronic device).

(D26) In some embodiments of D25, the computer system includes at least one of a computer machine wire-connected to the electronic device and a server that is communicatively coupled to the electronic device and a cloud database.

(D27) In some embodiments of any of D24-D26, the corpus of training data includes impedance data of the particles having the one or more known particle types.

(D28) In some embodiments of any of D24-D27, the corpus of training data comprises data from the particles having the one or more known particle types, the data including at least two of: optical data (e.g., optical imaging data or spectra with optical signatures of particles with known particle types that have labeled with optical labels), magnetic data (e.g., magnetic plots or spectra of particles with known particle types that have labeled with magnetic labels), and impedance data of the particles having the one or more known particle types.

(D29) In some embodiments of any of D24-D28, the corpus of training data are stored on a computer system that is communicatively coupled to the electronic device.

(D30) In some embodiments of any of D1-D29, the plurality of impedance values are obtained via a microfluidic device that is communicatively coupled to the electronic device.

(D31) In some embodiments of D30, obtaining the plurality of impedance values includes: extracting the plurality of first impedance values from an impedance profile (e.g., a time series plot of impedance values over time) as the plurality of sample particles are input into the microfluidic device.

(D32) In some embodiments of D30 or D31, the steps of inputting and applying are performed while the plurality of impedance values are determined by the microfluidic device (e.g., in real time or near real time, e.g., within 5 milliseconds, within 10 milliseconds, within 50 milliseconds). Stated another way, each sample's latency rate is comparable with a sampling time.

(D33) In some embodiments of any of D1-D32, the electronic device includes a processor unit and a microfluidic device electrically coupled to the processor unit, and the processor unit includes one or more of: a microcontroller unit, a field programmable gate array (FPGA), an application-specific integrated circuit (ASIC), and a chiplet module.

(D34) In some embodiments of any of D1-D33, the target particle classification model is applied substantially in real time while the plurality of first impedance values are obtained.

(D35) In some embodiments of any of D1-D34, each particle of the plurality of particles comprises a cell.

(E1) In accordance with some embodiments, a system for classifying individual particles comprises a microfluidic device having a microfluidic channel arranged on a substrate; an optical or magnetic sensing zone arranged along a first portion of the microfluidic channel; and an electrical sensing zone arranged along a second portion of the microfluidic channel. The system comprises an electronic device having one or more processors and memory. The memory stores one or more programs configured for execution by the one or more processors. The one or more programs include instructions for performing the method of any of D1-D35.

(F1) In accordance with some embodiments, a non-transitory computer-readable storage medium includes instructions that, when executed by an electronic device, cause the electronic device to perform the method of any of D1-D35.

(G1) In accordance with some embodiments, a method for classifying individual particles is performed at an electronic device having one or more processors, and memory storing one or more programs configured for execution by the one or more processors. The method includes obtaining optical sensing data or magnetic sensing data associated with a plurality of test particles; determining a plurality of test cell profiles wherein each test cell profile of the plurality of test cell profiles is based on the optical sensing data or the magnetic sensing data; obtaining a plurality of impedance values wherein each impedance value corresponds to each test cell of the plurality of test particles; inputting the plurality of impedance values of the plurality of test particles into a target cell classification model; and applying, locally in the electronic device, the target cell classification model to the plurality of impedance values of the plurality of test particles to determine a respective cell type classification for each cell of the plurality of test particles.

(G2) In some embodiments of G1, the method further comprising, prior to inputting the plurality of impedance values of the plurality of test particles into the target cell classification model: obtaining optical sensing data or magnetic sensing data associated with a plurality of reference particles; determining a plurality of reference cell profiles wherein each reference cell profile of the plurality of reference cell profiles is based on the optical sensing data or the magnetic sensing data; obtaining a plurality of reference impedance values wherein each reference impedance value corresponds to each reference cell of the plurality of reference particles; and adjusting one or more model parameters of a generic cell classification model according to the plurality of reference impedance values to generate the target cell classification model.

(G3) In some embodiments of G2, the adjusting the one or more model parameters of the generic cell classification model further comprises, iteratively: applying that generic cell classification model that is being adjusted to the plurality of reference impedance values to determine an adjusted cell type classification for each test cell of the plurality of test particles; generating an adjusted test cell profile of the plurality of test particles based on the adjusted cell type classification; and updating the one or more model parameters of the generic cell classification model until a difference between the adjusted test cell profile and the reference cell profile satisfies a loss criterion.

(H1) In accordance with some embodiments, a system for classifying sample properties, comprises a microfluidics chip and a device. The microfluidic chip comprises a plurality of microfluidic channels, an optical sensing zone, an impedance sensing zone, and piezoelectric actuators. The device comprises an optical sensor, an impedance sensor circuit, and a micro-controller unit (MCU). The device senses the sample feature from the microfluidic chip, and collects and records the sample feature.

(H2) In some embodiments of H1, the device connects to a first cloud database storing optical sensing results to classify optical data sensed by microfluidic chip. The device also connects to a second cloud database storing impedance sensing results to classify impedance data sensed by the microfluidic chip.

(H3) In some embodiments of H2, the optical data sensed by the device or the microfluidic chip are classified using a first AI image recognition algorithm, based on the first cloud database for optical sensing results. A result of the rough optical classification is referred to next classification by impedance sensing so that second AI algorithm determines a classification from the narrower scope of the second cloud database stored impedance sensing results.

(H4) In some embodiments of H3, the result of classification by impedance data are fed back to the first AI algorithm for classifying optical sensed data so as to be more accurate and speedy optical sensing classification.

(H5) In some embodiments of any of H1-H4, the optical sensing is executed by at least one optical image sensor and/or Raman spectroscopy.

(H6) In some embodiments of any of H1-H5, the impedance sensing is executed by at least one split ring resonator and/or one or more pair of parallel electrodes and/or one or more pair of counter electrodes.

(H7) In some embodiments of any of H1-H6, the piezoelectric actuator placed adjacent to microfluidic channel is programmed to drive the piezoelectric actuator at a known frequency by the MCU, complied with the result of sample properties classification. The microfluidic channel has plurality of channels at downstream from impedance sensing zone, and the sample sensed at impedance sensing zone, is labeled and separated to which microfluidic channel the sample goes at downstream from impedance sensing zone.

(H8) In some embodiments of any of H1-H7, the sample is a single biological particle, a tissue sample, or a sample of nanoparticles.

(H9) In some embodiments of any of H1-H8, the first cloud data-base stored optical sensing results has data correlated or linked between optical images and sample properties. In order to classify the sample properties speedy, the correlation between optical images and sample properties are rough classification. The first A1 image recognition is executed to classify by pooling method and pick up a taxon correlated to optical sensed data. The information which picked the taxon by the first AI, is shared with the second AI. In order to classify the sample properties faster, the second cloud data-base stored impedance sensing results has data correlated or linked between impedance sensing data and sample properties herein the second AI by convolutional method, can select from a narrow scope of sample characteristic by optical sensed classification. The device shows a result of the classification.

(I1) In accordance with some embodiments, a microfluidic device comprises: one or more microfluidic chips; one or more optical sensors; one or more impedance sensing circuits; one or more microcontroller units (MCUs) executing an edge AI processor or algorithm, and connection tool with outside database network wherein: the one or more microfluidic chips include a first microfluidic chip comprising: at least one inlet, at least one outlet, a plurality of microfluidic channels, an optical sensing zone, an impedance sensing zone, a plurality of electrode, one or more piezoelectric actuators, and electrical connection wiring.

(I2) In some embodiments of I1, the one or more optical sensors are placed a position so as to detect, analyze, or evaluate a sample passing through an optical sensing zone in the first microfluidic chip.

(I3) In some embodiments of I1 or I2, the one or more impedance sensing circuit connect to a plurality of electrodes of the microfluidic chip so as to detect, analyze, or evaluate a sample passing through impedance sensing zone in microfluidic chip.

(I4) In some embodiments of any of I1-I3, the one or more MCUs are electrically coupled to the one or more optical sensors, the one or more impedance sensing circuit, the edge AI also, piezoelectric actuators in the microfluidic chip, wherein: the one or more MCU communicates to the piezoelectric actuator in the microfluidic chip according to a result of the optical sensing and the impedance sensing.

(I5) In some embodiments of I4, the one or more MCU communicates to the edge AI to classify optical sensed data from the optical sensor, wherein: the edge AI communicates to a first cloud database for optical sensing results and then the edge AI compares the optical sensed data with stored data in the first cloud database to classify the result of the optical sensed data.

(I6) In some embodiments of I5, the one or more MCU communicates to the edge AI to classify impedance sensed data from the impedance sensor, wherein: the edge AI communicates to a second cloud database for impedance sensing results and then the edge AI compares the impedance sensed data with stored data in the second cloud database to classify the result of the impedance sensed data.

(I7) In some embodiments of I5 or I6, the classification result by optical sensed data are fed back to the edge AI to classify impedance sensed data from a narrower scope of the second cloud database for impedance sensing results.

(I8) In some embodiments of any of I5-I7, the result of the classification by impedance sensed data are fed back to the edge AI to classify optical sensed data and the edge AI does continuous machine learning by correlation between optical sensed data and impedance sensed data.

(I9) In some embodiments of any of I1-I8, the one or more MCUs communicate to the piezo actuator in microfluidic chip so as to control flow of samples.

(I10) In some embodiments of any of I1-I9, the microfluidic device further comprises one or more monitors to show real time analyzing of the optical sensing and impedance sensing, also results of the classification of the sample.

(I11) In some embodiments of any of I1-I10, the connection tool with outside database network are one or more connection tools USB, WIFI, Bluetooth, RF, LTE, lightning, Zigbee, Ultra-Wide Band, Induction, Magnetic coil.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

What is claimed is:

1. A system for classifying individual particles, the system comprising:
a microfluidic device having;
a microfluidic channel arranged on a first substrate;
an optical or magnetic sensing zone arranged along a first portion of the microfluidic channel; and
an electrical sensing zone arranged along a second portion of the microfluidic channel; and
an electronic device having one or more processors, and memory storing one or more programs configured for execution by the one or more processors, the one or more programs including instructions for:
obtaining a plurality of impedance values corresponding to a plurality of sample particles of a target sample, wherein a respective particle of the sample particles corresponds to a respective impedance value of the plurality of impedance values;
inputting the plurality of impedance values into a first target particle classification model; and
applying, locally in the electronic device, the first target particle classification model to the plurality of impedance values to determine a respective particle type classification for each particle of the plurality of sample particles.

2. The system of claim 1, the one or more programs further including instructions for:
obtaining optical or magnetic data providing coarse classification information of the target sample; and
inputting the optical or magnetic data jointly with the plurality of impedance values into the first target particle classification model,
wherein the first target particle classification model is applied to process both the plurality of impedance values and the optical or magnetic data to determine the respective particle type classification for each sample particle.

3. The system of claim 2, wherein the optical or magnetic data include a coarse particle type classification for each sample particle or a coarse particle profile of the target sample.

4. The system of claim 1, the one or more programs further including instructions for:
obtaining optical or magnetic data providing coarse classification information of the target sample before obtaining the plurality of impedance values corresponding to the sample particle of the target sample; and
inputting the optical or magnetic data into a second target particle classification model,
wherein the second target particle classification model is applied to process the optical or magnetic data to coarsely determine the respective particle type classification for each sample particle.

5. The system of claim 4, the one or more programs further including instructions for:
giving feedback of the coarsely determined respective particle type classification of the respective particle type classification for each sample particle by optical or magnetic data, to the first target particle classification model,
wherein candidates of particle type classification for each sample particle in the first target particle classification model, are narrowed down to less than 80% of the first target particle classification model.

6. The system of claim 1, the one or more programs further including instructions for:
enabling labeling of each of at least a subset of the impedance values corresponding to the plurality of sample particles with the respective particle type classification to obtain a labeled dataset; and
adding the labeled subset of the impedance values into a corpus of training data for retraining the target particle classification model.

7. The system of claim 1, wherein the plurality of impedance values form a temporal series of first impedance data, the one or more programs further including instructions for:
executing an entropy optimization engine application in which the first target particle classification model is applied to determine the respective particle type classification for each sample particles;
displaying a user interface associated with the entropy optimization engine application; and
visualizing, on the user interface, the respective particle type classifications of the plurality of sample particles.

8. The system of claim 1, the one or more programs further including instructions for:
prior to inputting the plurality of impedance values into the first target particle classification model:
obtaining a plurality of test impedance values corresponding to a reference sample including a plurality of test particles, the reference sample distinct from the target sample;
obtaining a ground truth including a plurality of concurrent optical or magnetic signatures for the plurality of test particles; and
adjusting one or more model parameters of a generic particle classification model according to the plurality of test impedance values to generate the first target particle classification model.

9. The system of claim 8, the one or more programs further including instructions for:
before obtaining the plurality of test impedance values, measuring optical sensing data or magnetic sensing data associated with the plurality of test particles; and
determining the plurality of concurrent optical or magnetic signatures based on the optical sensing data or magnetic sensing data.

10. The system of claim 1, wherein the first target particle classification model includes a high precision classifier tree, the one or more programs further including instructions for:
prior to inputting the plurality of impedance values into the first target particle classification model:
obtaining test optical or magnetic imaging data and test impedance values of a plurality of reference samples;
determining an initial dataset using the test optical or magnetic imaging data;
training an intermediate classifier tree with the initial dataset;
applying the intermediate classifier tree to the test impedance values to generate an updated dataset; and
applying the updated dataset to retrain the intermediate classifier tree to generate the high precision classifier tree.

11. The system of claim 1, the one or more programs further including instructions for:
grouping the plurality of impedance values to a first sequence of impedance value groups, wherein the first target particle classification model is applied on each group of the first sequence of impedance value groups successively with a first classification frequency.

12. The system of claim 1, the one or more programs further including instructions for:
after inputting the plurality of impedance values into the first target particle classification model, retraining the first target particle classification model according to the plurality of impedance values to generate an updated particle classification model.

13. The system of claim 1, the one or more programs further including instructions for:
storing the first target particle classification model locally on the electronic device.

14. The system of claim 1, the one or more programs further including instructions for:
storing a plurality of particle type classifications including the respective particle type classification of each of a subset of the plurality of sample particles on the electronic device.

15. A microfluidic device, comprising:
a microfluidic channel arranged on a first substrate;
an optical sensing zone arranged along a first portion of the microfluidic channel; and
an electrical sensing zone arranged along a second portion of the microfluidic channel, the electrical sensing zone including a set of electrodes and a set of piezoelectric actuators.

16. The microfluidic device of claim 15, further comprising control circuitry coupled to the set of piezoelectric actuators and the set of electrodes, wherein the control circuitry is configured to adjust operation of the set of piezoelectric actuators and the set of electrodes.

17. The microfluidic device of claim 16, wherein the control circuitry comprises one or more machine learning components, wherein the one or more machine learning components are configured to classify particles in a fluidic sample based on data from one or more of the optical sensing zone and the electrical sensing zone.

18. The microfluidic device of claim 15, wherein the set of piezoelectric actuators are configured to cause manipulation of a particle while the particle is in the electrical sensing zone.

19. The microfluidic device of claim 15, wherein the microfluidic channel is formed by coupling the first substrate with a second substrate via a bonding layer.

20. The microfluidic device of claim 19, wherein at least a portion of the second substrate is at least partially transparent such that optical sensing in the optical sensing zone is performed through the second substrate.
